(19) United States
(12) Patent Application Publication
(10) Pub. No.: US 2024/0142714 A1
(43) Pub. Date: May 2, 2024

(54) FIBER OPTIC CONNECTION ASSEMBLY AND FIBER OPTIC INSTALLATION METHODS

(71) Applicant: Senko Advanced Components, Inc., Hudson, MA (US)

(72) Inventors: Yim WONG, Kowloon (HK); Man Kit Joe WONG, Kowloon (HK)

(21) Appl. No.: 18/497,134

(22) Filed: Oct. 30, 2023

Related U.S. Application Data
(60) Provisional application No. 63/420,524, filed on Oct. 28, 2022.

(51) Int. Cl. G02B 6/38

(52) U.S. Cl. CPC G02B 6/3825; G02B 6/387; G02B 6/3893

(57) ABSTRACT

A fiber optic connection assembly includes a cage and an adapter assembly releasably securable in the cage. The adapter assembly includes an insert cartridge and an adapter in the insert cartridge. The adapter maters with fiber optic connectors. The insert cartridge has at least one actuator for selectively releasing the adapter assembly from the cage. The adapter assembly is bi-directionally loadable into and extractable from the cage. The fiber optic connection assembly is usable to install a fiber optic trunk cable by plugging a trunk cable connector into the adapter before inserting the adapter assembly into the cage. The adapter assembly can also be extracted from the cage while one or more connectors remain mated with the adapter.

### CROSS-REFERENCE TO RELATED APPLICATION

This application claims priority to U.S. Provisional Patent Application No. 63/420,524, filed Oct. 28, 2022, which is hereby incorporated by reference in its entirety.

### FIELD

This disclosure generally pertains to passive fiber optic connection assemblies and fiber optic installation methods.

### BACKGROUND

Fiber optic network operators have a need for greater fiber connection density. To accommodate that need, makers of passive fiber optic components have developed a new generation of fiber optic components called “very small form factor” (VSFF) components. The introduction of these components has unlocked new possibilities for fiber optic network design. However, VSFF components are very small and can be difficult to handle.

One common fiber optic connection system employs an adapter that mates with connectors at two ends to make one or more optical connections between opposing connectors. In high density fiber optic network applications, adapters are installed on a panel (e.g., using panel clips). The front end of the adapter is exposed on the front side of the panel, and the back end of the adapter is exposed on the back side. After the adapter is mounted on the panel, one or more connectors are inserted into one or more receptacles on the back side, and a corresponding number of connectors are inserted on the front side to make optical connections. The individual connectors must be removed from the adapters if cabling adjustments are needed.

### SUMMARY

In one aspect, a fiber optic connection assembly configured to mate with at least one fiber optic connector comprises a cage having a front end portion and a back end portion spaced apart along the longitudinal axis. The cage defines an assembly opening extending from the front end portion through the back end portion. The cage comprises a latch element. An adapter assembly is configured to latch with the latch element to be releasably secured in the assembly opening. The adapter assembly has at least one receptacle for receiving the at least one fiber optic connector. The adapter assembly is loadable into the assembly opening by (i) inserting the adapter assembly forward into the back end portion of the cage and (ii) inserting the adapter assembly backward into the front end portion of the cage. The adapter assembly comprises a bidirectional extraction mechanism configured to be selectively actuated for unloading the adapter assembly from the assembly opening by (a) extracting the adapter assembly backward from the back end portion of the cage and (b) extracting the adapter assembly forward from the front end portion of the cage.

In another aspect, a method of installing a fiber optic trunk cable comprises plugging one or more trunk cable connectors terminating the trunk cable into one or more back receptacles of an adapter assembly. After said plugging, the adapter assembly is inserted forward into a back end portion of a cage to load the adapter assembly into an assembly opening of the cage.

In another aspect. a fiber optic connection assembly comprises a cage having a front end portion and a back end portion spaced apart along a longitudinal axis. The cage has an assembly opening extending from the front end portion through the back end portion. An adapter assembly is releasably secured in the assembly opening. The adapter assembly has at least one front receptacle and at least one back receptacle. At least one front connector is mated with the adapter assembly in the at least one front receptacle. At least one back connector is mated to the receptacle in the at least one back receptacle. The adapter assembly secures the at least one front connector and the at least one back receptacle such that an optical connection is made between the at least one front connector and the at least one back connector. The adapter assembly is selectively releasable from the cage such that the adapter assembly can be extracted backward from the back end portion of the cage while the at least one front connector remains mated with the adapter assembly in the at least one front receptacle and the at least one back connector remains mated with the adapter assembly in the at least one back receptacle. The adapter assembly is also selectively releasable from the cage such that the adapter assembly can be extracted forward from the front end portion of the cage while the at least one front connector remains mated with the adapter assembly in the at least one front receptacle and the at least one back connector remains mated with the adapter assembly in the at least one back receptacle.

Other aspects will be in part apparent and in part pointed out hereinafter.

### BRIEF DESCRIPTION OF THE DRAWINGS

FIG. 1 is a perspective fiber optic connection assembly in accordance with the present disclosure;

FIG. 2 is a front elevation of the fiber optic connection assembly;

FIG. 3 is an exploded perspective of the fiber optic connection assembly;

FIG. 4 is a perspective of a cage of the fiber optic connection assembly;

FIG. 5 is another perspective of the cage;

FIG. 6 is a front end elevation of the cage;

FIG. 7 is a cross-sectional perspective of the cage wherein the cross-section is taken in the plane of line 7-7 of FIG. 6;

FIG. 8 is a cross-sectional perspective of the cage wherein the cross-section is taken in the plane of line 8-8 of FIG. 6;

FIG. 9 is a cross section taken in the plane of line 9-9 of FIG. 6;

FIG. 10 is a cross section taken in the plane of line 10-10 of FIG. 6;

FIG. 11 is a perspective of an insert cartridge of the fiber optic connection assembly;

FIG. 12 is a front elevation of the insert cartridge;

FIG. 13 is an exploded perspective of the insert cartridge;

FIG. 14 is a perspective of a main body of the insert cartridge;

FIG. 15 is a perspective of an actuator of the insert cartridge;

FIG. 16 is another perspective of the actuator;

FIG. 17 is an end elevation of the actuator

FIG. 18 is a cross section taken in the plane of line 18-18 of FIG. 12;

FIG. 19 is a cross section taken in the plane of line 19-19 of FIG. 12;

FIG. 20 is a perspective of a retainer of the insert cartridge;

FIG. 21 is another perspective of the retainer

FIG. 22 is a fragmentary perspective of the insert cartridge;

FIG. 23 is another fragmentary perspective of the insert cartridge

FIG. 24 is a cross section taken in the plane of line 24-24 of FIG. 12;

FIG. 25 is a cross section taken in the plane of line 25-25 of FIG. 12;

FIG. 26 is a cross section taken in the plane of line 26-26 of FIG. 12;

FIG. 27 is a cross section similar to FIG. 26 except showing one of the actuators of the insert cartridge in an actuating position;

FIG. 28 is a top plan view of the insert cartridge;

FIG. 29 is a top plan view similar to FIG. 28 except showing one of the actuators of the insert cartridge in an actuating position;

FIG. 30 is a perspective illustration of an adapter being loaded backward into the insert cartridge;

FIG. 31 is a cross section showing the adapter being loaded into the insert cartridge;

FIG. 32 is a cross section similar to FIG. 31 but showing the adapter loaded into the insert cartridge;

FIG. 33 is another cross section showing the adapter and insert cartridge positioned so that the adapter can be loaded backward into the insert cartridge;

FIG. 34 is a cross section similar to FIG. 33 showing the adapter moved backward so that it is partially received in the insert cartridge;

FIG. 35 is a cross section similar to FIG. 34 showing the adapter moved further backward into the insert cartridge;

FIG. 36 is a cross section similar to FIG. 35 showing the adapter moved still further backward so that it is fully loaded in the insert cartridge;

FIG. 37 is a perspective showing an adapter assembly comprising the adapter loaded in the insert cartridge and the cage positioned so that the adapter assembly can be loaded backward into the cage;

FIG. 38 is a perspective showing the adapter assembly and the cage positioned so that the adapter assembly can be loaded forward into the cage;

FIG. 39 is a fragmentary perspective of the adapter assembly being loaded backward into the cage wherein a portion of the insert cartridge is broken away;

FIG. 40 is another fragmentary perspective of the adapter assembly being loaded backward into the cage wherein a portion of the insert cartridge is broken away;

FIG. 41 is a cross section showing the adapter assembly being loaded backward into the cage;

FIG. 42 is a cross section similar to FIG. 41 showing the adapter assembly fully loaded in the cage;

FIG. 43 is another cross section showing the adapter assembly being loaded into the cage;

FIG. 44 is a cross section similar to FIG. 43 showing the adapter assembly moved further backward in the cage;

FIG. 45 is a cross section similar to FIG. 44 showing the adapter assembly moved further backward where it is fully loaded in the cage;

FIG. 46 is a perspective of the fiber optic connection assembly including a schematic arrow to indicate how the adapter assembly can be extracted from the cage in the forward direction;

FIG. 47 is a perspective of the fiber optic connection assembly including a schematic arrow to indicate how the adapter assembly can be extracted from the cage in the backward direction;

FIG. 48 is a cross section of the fiber optic connection assembly;

FIG. 49 is a cross-sectional perspective of the fiber optic connection assembly;

FIG. 50 is a cross section of the fiber optic connection assembly showing an actuator pulled backward to an actuating position;

FIG. 51 is a cross section of the fiber optic connection assembly in a loaded configuration;

FIG. 52 is another cross section of the fiber optic connection assembly a loaded configuration;

FIG. 53 is a cross section similar to FIG. 51 showing an actuator pulled backward to an actuating position for extracting the adapter assembly backward from the cage;

FIG. 54 is a cross section similar to FIG. 51 showing the fiber optic connection assembly in the configuration of FIG. 53;

FIG. 55 is a perspective of a plurality of fiber optic connection assemblies in a vertical stack;

FIG. 56 is a cross section of a plurality of fiber optic connection assemblies in a side-by-side stack;

FIG. 57 is a perspective of a panel flange member;

FIG. 58 is another perspective of the panel flange member;

FIG. 59 is an exploded perspective of an assembly including a side-by-side stack of fiber optic connection assemblies and two panel flange members;

FIG. 60 is an exploded cross section of the assembly of FIG. 59;

FIG. 61 is a perspective of the assembly of FIG. 59 secured to a panel;

FIG. 62 is another perspective of the assembly of FIG. 59 secured to a panel;

FIG. 63 is a cross section of the assembly of FIG. 59 secured to a panel;

FIG. 64 is a perspective showing two uniboot connectors positioned to be inserted into opposite ends of the fiber optic connection assembly;

FIG. 65 is a perspective of the two uniboot connectors mated with the adapter assembly;

FIG. 66 is an elevation of the two uniboot connectors mated with the adapter assembly;

FIG. 67 is a top plan view of the two uniboot connectors mated with the adapter assembly;

FIG. 68 is a perspective showing the adapter assembly and mated uniboot connectors positioned to be loaded into the cage;

FIG. 69 is a perspective of the two uniboot connectors mated with the adapter assembly and loaded into the cage;

FIG. 70 is an elevation of the assembly of FIG. 69;

FIG. 71 is a top plan view of the assembly of FIGS. 69 and 70;

FIG. 72 is a perspective showing the adapter assembly and mated uniboot connectors extracted forward from the cage;

FIG. 73 is a perspective showing the adapter assembly and mated uniboot connectors extracted backward from the cage; and

FIG. 74 is a perspective of another embodiment of a fiber optic connection assembly having pull tabs on a same side of the adapter assembly.

Corresponding parts are given corresponding reference characters throughout the drawings.

### DETAILED DESCRIPTION

The inventors believe that improvements can be made to conventional adapter-based fiber optic connection systems, more particularly, that fiber optic network installation can be improved by employing an adapter assembly that can be installed from either side of the panel while one or more connectors are mated to the adapter. In addition, the inventors believe that fiber optic network installation can be improved by facilitating bidirectional extraction of the adapter assembly from its installed position without removal of the connectors mated thereto.

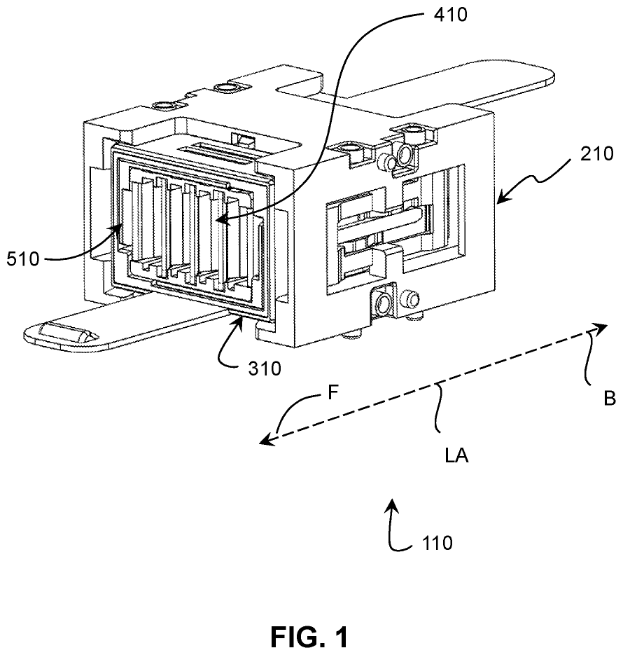

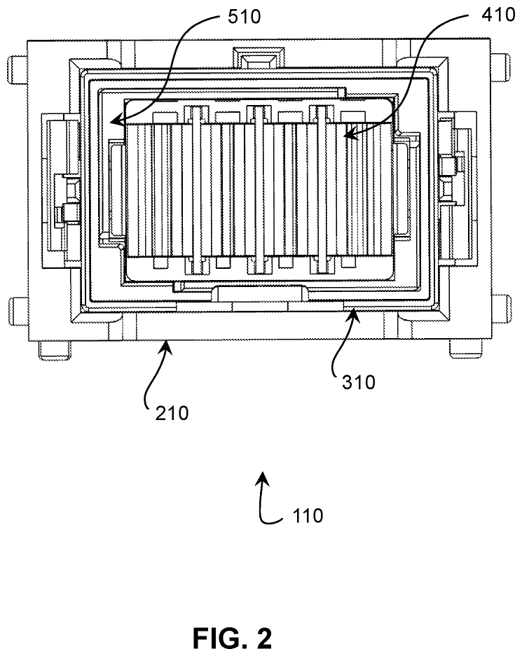

Referring to FIGS. 1-3, an exemplary embodiment of a fiber optic connection assembly in accordance with the present disclosure is generally indicated at reference number 110. The connection assembly 110 broadly comprises a cage 210 configured to receive and hold an adapter assembly 310. The adapter assembly 310 comprises an adapter 410 received inside an insert cartridge 510. As will be explained in further detail below, the insert cartridge 510 is configured to facilitate bidirectional insertion and extraction of the adapter 410 into the cage 210. The cage 210 is broadly configured to for supporting the adapter 410 on fiber optic equipment, e.g., fiber optic rack equipment and/or adapter panels.

Any suitable type of adapter having one or more receptacles in which to receive one or more fiber optic connectors can be used without departing from the scope of the disclosure. In the illustrated embodiment, the adapter 410 is a multiport VSFF adapter. More specifically, the illustrated adapter 410 is a quad SN adapter having four front receptacles 412 (FIG. 34) for receiving SN connectors and four back receptacles 414 for receiving SN connectors. Other types of VSFF adapters include MDC adapters, SN-MT adapters, and MMC adapters, which are all known to those skilled in the art. This disclosure is also not limited to VSFF adapters. Conventional small form factor adapters, such as LC adapters, MU adapters, and MPO adapters, as well as larger format adapters like SC adapters, ST adapters, etc., may all be used without departing from the scope of the disclosure.

As shown in FIG. 34, the front and back receptacles 412, 414 are spaced apart along a longitudinal axis LA of the fiber optic connection system 110. The front receptacles 412 are spaced apart from the back receptacles 412 in a forward direction F along the longitudinal axis LA. Conversely, the back receptacles 414 are spaced apart from the front receptacles 412 in a backward direction B, opposite to the forward direction F. In the illustrated embodiment, the adapter 410 comprises a shutter system 416 across the front end of the adapter to cover the front receptacles 412 when unmated. There is no shutter system over the back receptacles 414 of the illustrated adapter 410. In other embodiments, it is contemplated that a shutter system could also be installed across the back receptacles or that no shutters are used. For purposes of determining front-back orientation in the drawings, whenever the adapter 410 is depicted, the shutter system 416 is located at the front end of the adapter and the back end of the adapter is uncovered by the shutters. While the orientation of other components of the fiber optic connection assembly 110 in relation to the adapter 410 changes throughout the drawings, the location of the shutter system 416 at a relatively forward position is a consistent reference point throughout.

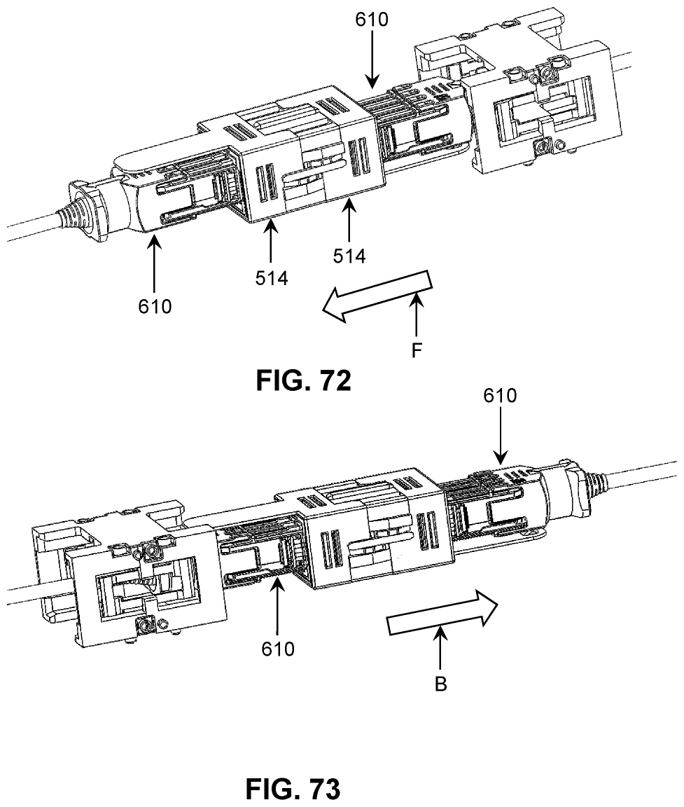

Those skilled in the art will recognize that the quad SN adapter 410 is configured for receiving quad SN uniboot connectors in the front and/or back receptacles 412, 414. Such uniboot connectors are shown in several drawings and generally indicated at reference number 610 (see, e.g., FIGS. 72-73). Those skilled in the art would appreciate that the uniboot connector is used for illustrative purpose only, and does not limit the scope of the embodiments herein. Other types of connectors or fiber optic devices may be applied with the fiber optic connection assembly in accordance with the present disclosure.

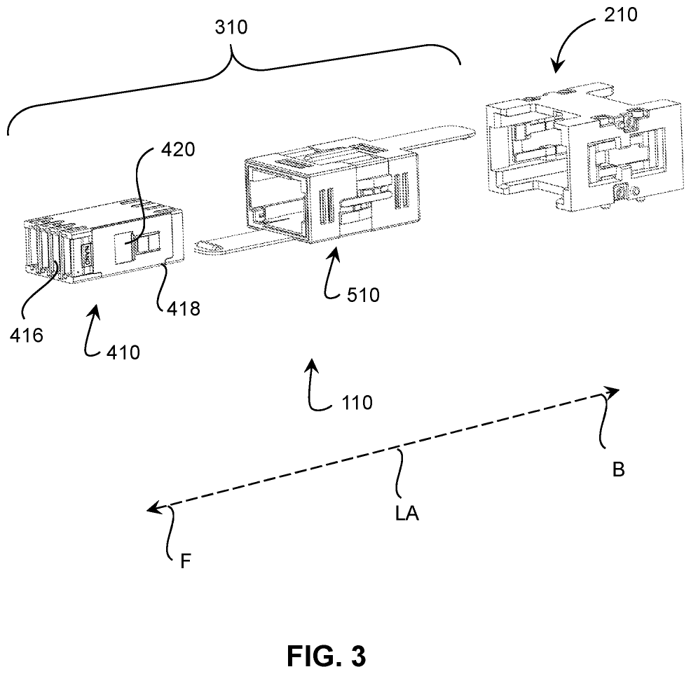

In the illustrated embodiment, the adapter 410 further comprises a standard metal panel clip 418 (FIG. 3). The panel clip 418 comprises opposing spring latches 420 on opposite sides of the adapter 410. As explained in further detail below, the panel clip 418 is used to secure the adapter 410 in the insert cartridge 510.

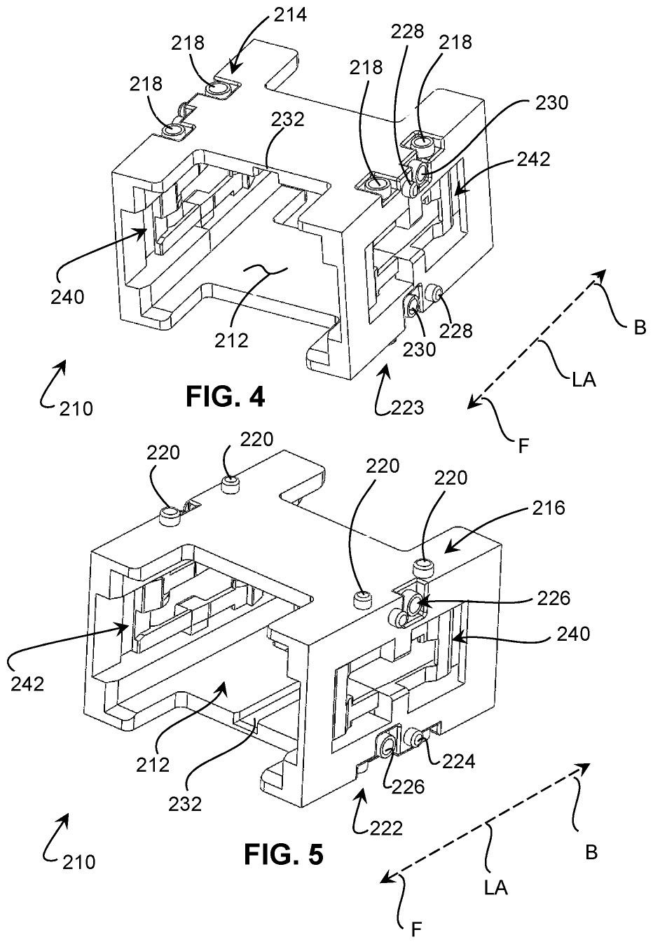

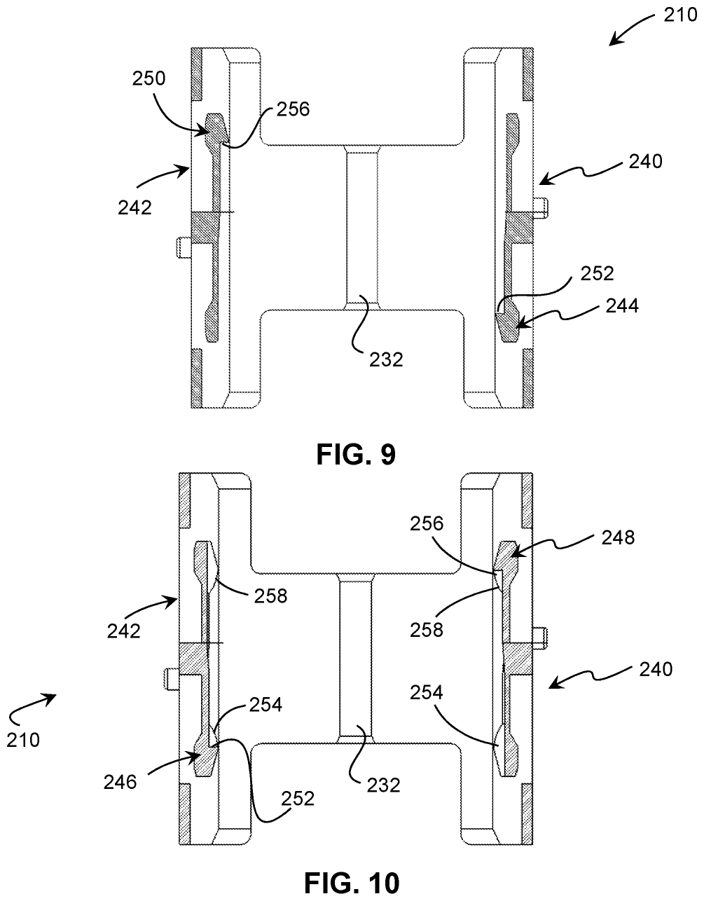

Referring to FIGS. 4-10, the cage 210 has a front end portion and a back end portion spaced apart along the longitudinal axis LA. The cage 210 defines an assembly opening 212 extending from the front end portion through the back end portion. The cage 210 is generally configured to releasably secure the adapter assembly 310 in the assembly opening 212. The cage 210 is generally rectangular, including an upper portion above the assembly opening 212, a lower portion below the assembly opening, a left portion along the left side of the assembly opening, and a right portion along the right side of the assembly opening.

In an exemplary embodiment, the cage 210 is configured to facilitate vertical and/or side-by-side stacking with similar cages. The upper portion of the cage 210 defines an upper stacking interface 214, and the lower portion of the cage defines a complementary lower stacking interface 216 configured to mate with the upper stacking interface of another similar cage. In the illustrated embodiment, the upper stacking interface comprises a plurality of sockets 218, and the lower stacking interface 216 comprises a plurality of posts 220. The posts are configured to be press fit into the sockets 218 of the upper stacking interface of another cage to secure the cages in vertically stacked relation. The left portion of the cage 210 defines a left stacking interface 222 and the right portion defines a complementary right stacking interface 223 configured to mate with the left stacking interface of another similar cage. In the illustrated embodiment, the left stacking interface 222 comprises an alternating pattern of posts 224 and sockets 226, and the right stacking interface 223 comprises complementary posts and sockets 228, 230. The left and right stacking interfaces 222, 223 of adjacent cages 210 can be press fit together so that the posts 224, 228 mate with the opposing sockets 226, 230 to secure the cages in side-by-side stacked relation.

In the illustrated embodiment, the upper portion of the cage 210 defines an internal polarity groove 232, whereas the lower portion of the cage is devoid of a polarity groove. The polarity groove 232 polarizes the cage 210 so that the adapter assembly 310 can only be inserted in one vertical orientation.

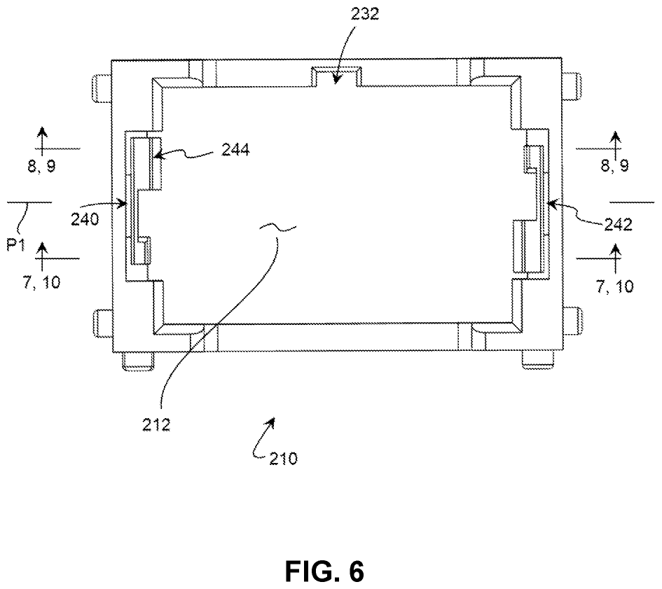

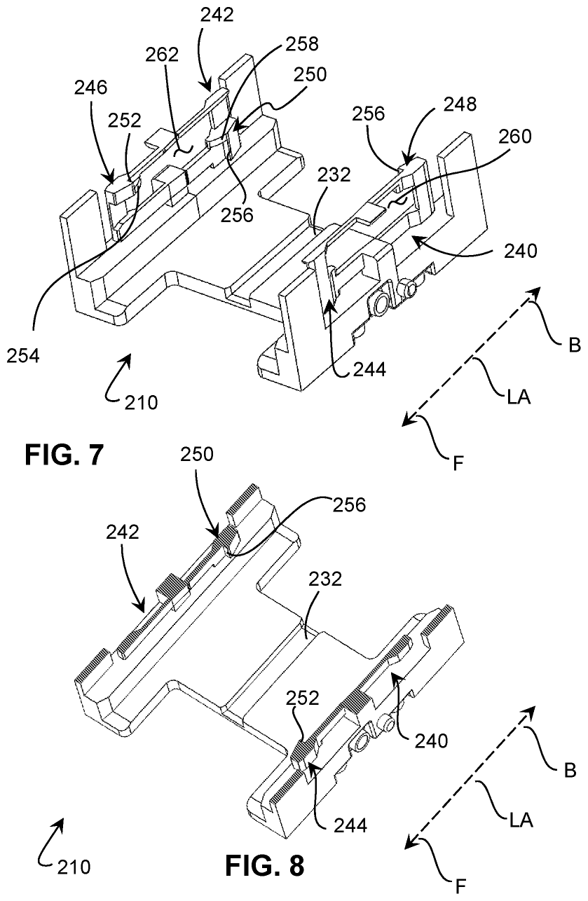

As shown in FIGS. 7-10, the left and right portions of the cage 210 further define left and right latch elements 240, 242. In FIGS. 7-10 the cage 210 is shown inverted so that the upper portion (with polarity groove 232) is depicted on bottom. Hence, in these illustrations, the left latch element 240 is on the right side of the page and the right latch element 242 is on the left side of the page. Each latch element 240, 242 comprises a respective front latch arm 244, 246 and a respective back latch arm 248, 250. Each front latch arm latch arm 244, 246 defines a respective backward facing latch hook 252 and a respective arcuate fillet 254 behind the latch hook. Each back latch arm 248, 250 defines a respective forward facing latch hook 256 and a fillet 258 in front of the forward facing latch hook. In the illustrated embodiment the front latch arm 244, 246 and the back latch arm 248, 250 of each latch element 240, 242 are separated by a respective gap 260, 262. The gaps 260, 262 are configured to accept portions of the adapter assembly 310, as described in further detail below. In the illustrated embodiment, the left latch element 240 is arranged so that the front latch arm 244 is spaced apart above the back latch arm 248. Conversely, the right latch element 242 is arranged so that the back latch arm 250 is spaced apart above the front latch arm 246. Hence, the left and right latch elements 240, 242 are arranged so that the front latch arms 244, 246 have opposite vertical positions in relation to a center horizontal plane P1 (FIG. 6) and so that the back latch arms 248, 250 likewise have opposite vertical positions in relation to the center horizontal plane P1

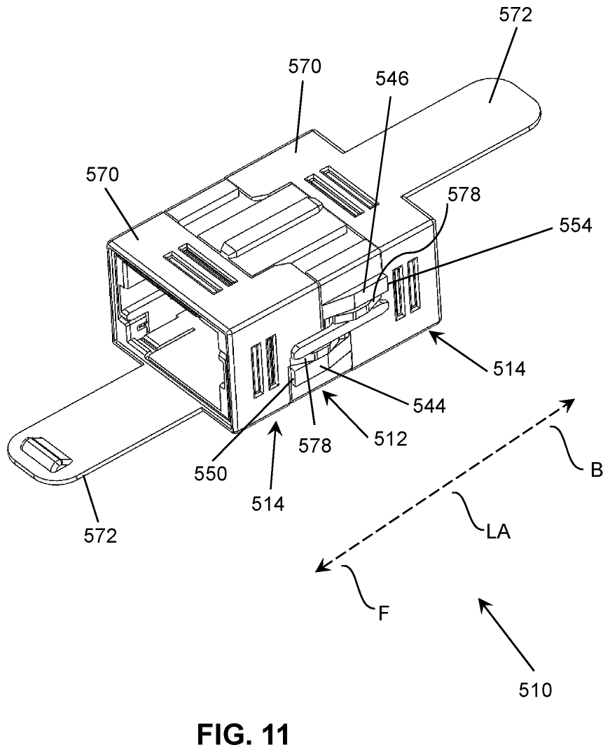

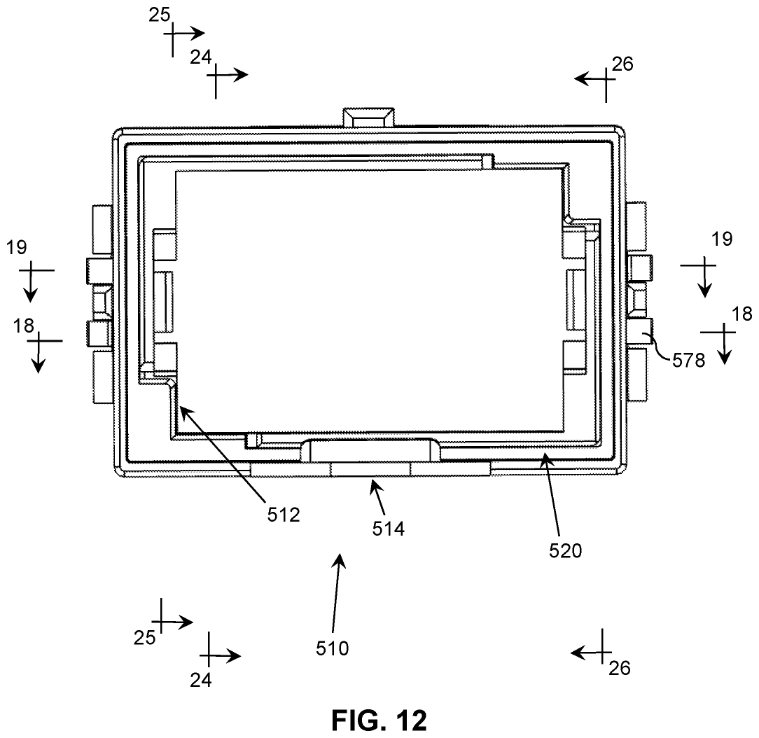

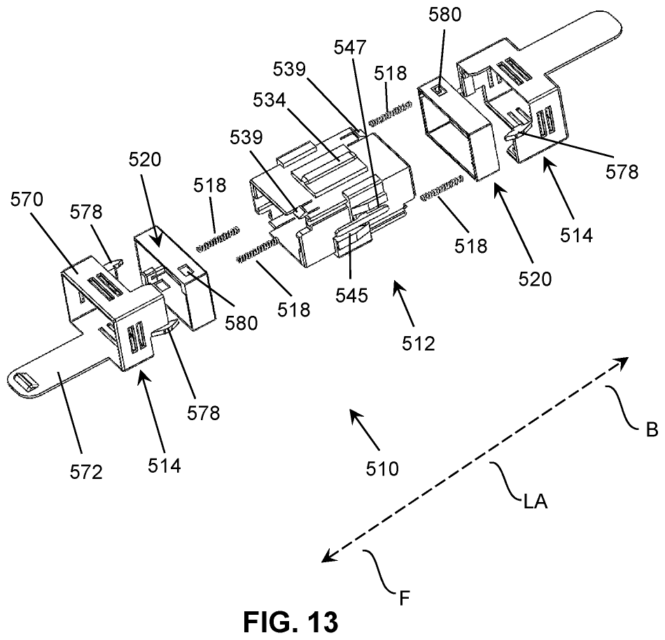

Referring to FIGS. 11-13, the insert cartridge 510 comprises a main body 512 and a bidirectional extraction mechanism including front and back actuators 514 movably connected to the main body. As will be explained in further detail below, each actuator 514 has a range of motion with respect to the main body 512 that includes an inner longitudinal position and an outer longitudinal position. The insert cartridge 510 further comprises actuator springs 518 (FIG. 13) that resiliently bias the actuators 514, 516 to their respective inner longitudinal positions. In the illustrated embodiment, the insert cartridge 510 further comprises front and back retainers 520 secured to the main body 512 to brace the outer ends of the actuator springs 518 and retain the actuators 514 on the main body.

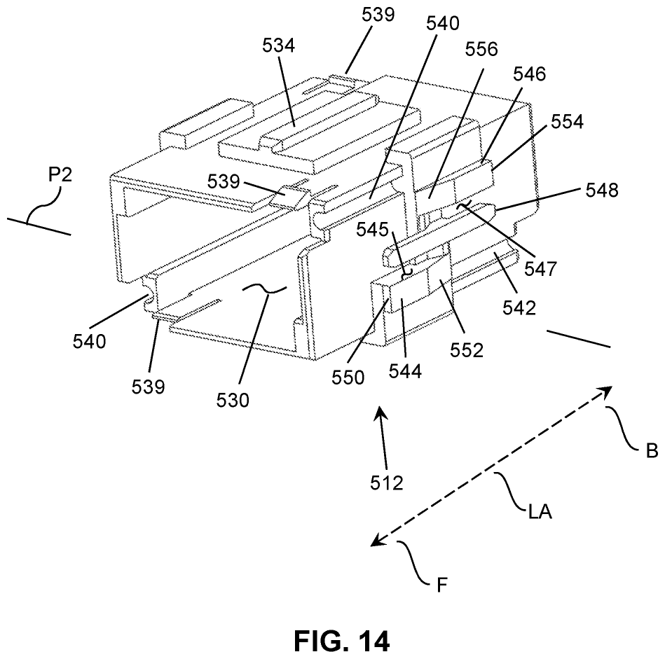

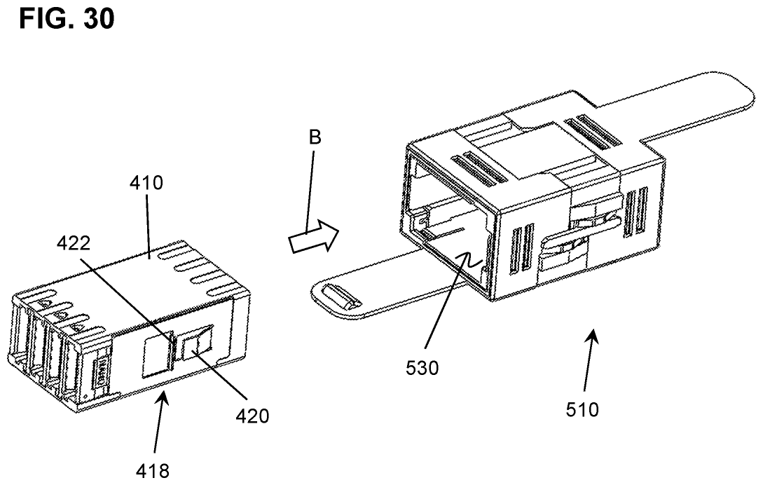

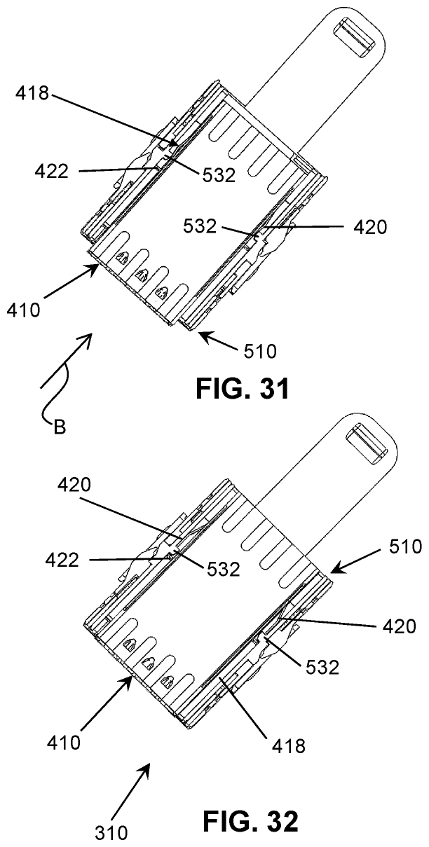

Referring to FIG. 14, the main body 512 defines an adapter opening 530 extending longitudinally from a front end portion through a back end portion. The main body 512 is configured to receive the adapter 410 in the adapter opening 530. More particularly, as shown in FIGS. 30-32, the main body 512 is configured so that the adapter 510 is insertable into the adapter opening 530 in the backward direction B through the front end of the main body. The panel clip 418 will latch with internal catch features 532 of the main body 512 to secure the adapter 410 inside the main body 510. Referring again to FIG. 14, the main body 512 is generally rectangular and includes an upper portion above the adapter opening 530, a lower portion below the adapter opening, a left portion along the left side of the adapter opening, and a right portion along the right side of the adapter opening. The upper portion of the main body 510 defines a polarity key 534 configured to be slidably received in the polarity groove 232 of the cage 210. The lower portion of the main body 512 is devoid of a polarity key. Accordingly, because of the shape of the main body 512, the cartridge 510 can only be inserted into the assembly opening 212 of the cage 210 in one vertical orientation (in which the upper portion of the main body is aligned with the upper portion of the cage so that the polarity key 534 slides into the polarity groove 232). The polarity key 534 will block insertion of the cartridge 510 if the main body is inverted in relation to the cage 210.

The upper and lower portions of the main body 512 further define retainer latches 539 configured for securing the retainers 520 to the outer end portions of the main body. In the illustrated embodiment, at each end of the main body 512, the retainer latches 539 are positioned at corner regions (adjacent to the respective spring channels 540, 542 described below). Accordingly, the font end portion of the illustrated main body 512 comprises an upper right retainer latch 539 and a lower left retainer latch. The back end portion of the main body 512 comprises an upper left retainer latch 539 and a lower right retainer latch (not visible in FIG. 14).

On the exterior of the main body 512, each of the left and right side portions defines a respective front spring channel 540, back spring channel 542, front snap-in element 544, back snap-in element 546, central guide rib 548, front guide slot 545, and back guide slot 547. The spring channels 540, 542 are configured to receive the actuator springs 518, the snap-in elements 544, 546 are configured to latch with the latch elements 240, 242 of the cage, and the guide rib 548 is configured to operatively align portions of the actuators 514 within the guide slots 545, 547 for selective unlatching of the adapter assembly 310 from the cage 210. In the illustrated embodiment the front and back spring channels 540, 542 and front and back snap-in elements 544, 546 on the left and right side portions of the main body 512 have opposite vertical positions in relation to a middle horizontal plane P2. The front spring channel 540 on the right side portion is spaced apart above the plane P2, whereas the front spring channel on the left side portion is spaced apart below the plane. Conversely, the back spring channel 542 on the right side portion is spaced apart below the middle horizontal plane P2, whereas the back spring channel on the left side portion (not visible in FIG. 14) is spaced apart above the middle horizontal plane. The front snap-in element 544 on the right side portion is spaced apart below a middle horizontal plane P2, whereas the front snap-in element on the left side portion (not visible in FIG. 14) is spaced apart above the middle horizontal plane. Conversely, the back snap-in element 546 on the right side portion is spaced apart above the middle horizontal plane P2, whereas the back snap-in element on the left side portion (not visible in FIG. 14) is spaced apart below the middle horizontal plane.

Each front snap-in element 544 defines a front catch 550 and a rear wedge 552. Conversely, each back snap-in element 546 defines a back catch 554 and a front wedge 556. The front and back snap-in elements 544, 546 on the left and right portions of the main body 512 are configured to facilitate bidirectional insertion of the adapter assembly 310 into the cage 210 such that the adapter assembly latches with the cage when inserted into the assembly opening 212 in either the forward direction F or the backward direction B. When the adapter assembly 310 is inserted backward (B) through the front end of the cage 210, the wedges 552 of the front snap-in elements 544 are configured to spread the front latch arms 244, 246 until the latch hooks 252 move longitudinally past the catches 550, at which point the latch arms rebound and the latch hooks latch with the catches. Conversely, when the adapter assembly 310 is inserted forward (F) through the back end of the cage 210, the wedges 556 of the back snap-in elements 546 are configured to spread the back latch arms 248, 250 until the latch hooks 256 move longitudinally past the catches 554, at which point the latch arms rebound and latch with the catches. As the adapter assembly 310 is inserted in either direction, the central guide tongues 548 are received in the central gaps 260, 262. Once the adapter assembly 310 has been loaded into the cage 210 such that it is secured within the assembly opening 212, the front catches 550 and the back catches 554 oppose the backward facing latch hooks 252 and the forward facing latch hooks 256, respectively, whereby the main body 512 is retained longitudinally between the front latch arms 244, 246 and the back latch arms 248, 250.

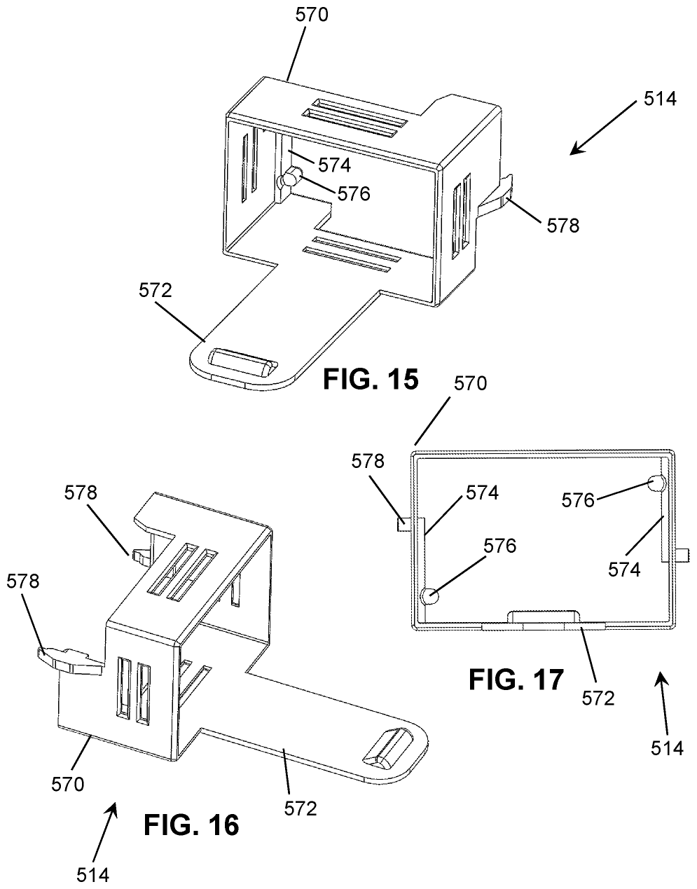

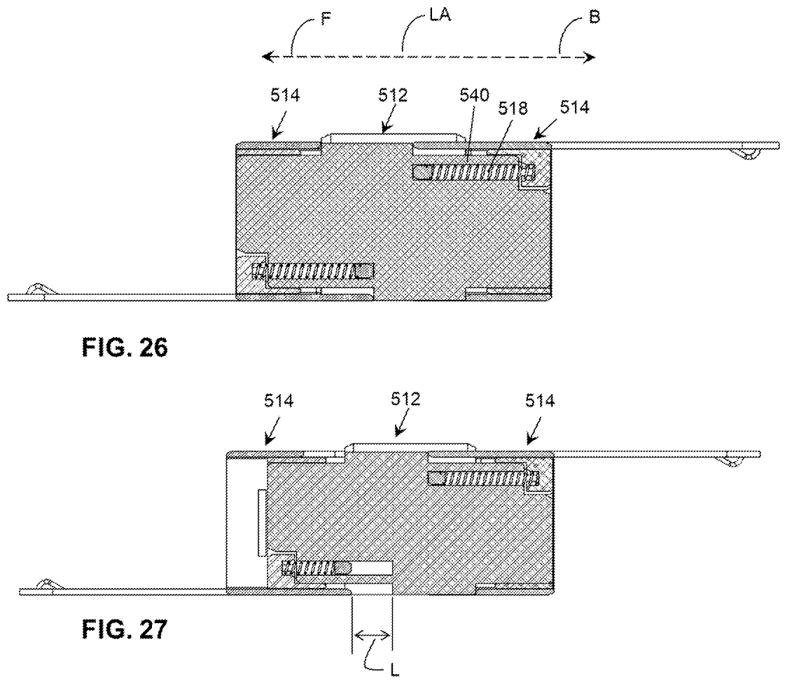

Referring to FIGS. 15-17, in the illustrated embodiment, the front and back actuators 514 are the same size and shape. Each actuator 514 comprises a rectangular shroud 570 configured to be positioned around the main body 512. A pull tab 572 protrudes longitudinally outward from an upper or lower wall of the shroud. The shroud 570 comprises opposite side walls. At diagonally opposite corner regions of the shroud 570, each of the side walls defines an inner front lip 574, a spring pad 576 protruding horizontally inward from the front lip, and an outer latch release wedge 578. When the shroud 570 of the front actuator 514 is operatively positioned around the main body 512, the spring pads 576 are slidably received in the front spring channels 540 behind the inner ends of the front actuator springs 518 (see FIG. 26). When the shroud of the back actuator 514 is operatively positioned around the main body 512, the spring pads 576 are slidably received in the back spring channels 542 in front of the inner ends of the back actuator springs (see FIG. 26). Accordingly, the spring pads 576 are operatively received in the spring channels 540, 542 so that the actuator springs 518 press on the spring pads to bias the front and back actuators 514 inward longitudinally.

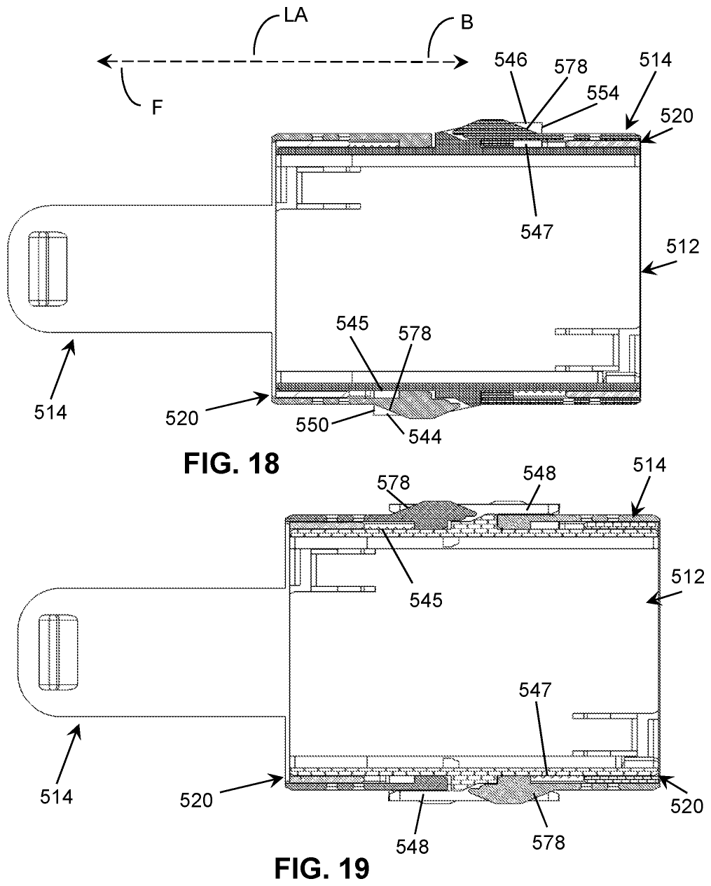

Each release wedge 578 defines an actuating wedge surface that faces outward longitudinally toward the pull tab 572. As shown in FIGS. 11 and 13, the release wedges 578 of the front actuator 514 are sized and arranged to be slidably received in the front guide channels 545 when the front actuator is installed on the front half of the main body 512. The release wedges 578 of the back actuator 514 are sized and arranged to be slidably received in the back guide channels 547 when the back actuator is installed on the back half of the main body 512. Referring to FIGS. 18 and 19, when the front and back actuators 514 are in their natural inner longitudinal positions, the release wedges are at the inner ends of the guide channels 545, 547. The wedges 578 of the front actuator are backward of the front catches 550, and the wedges of back actuator are forward of the back catches 554. Each actuator 514 is configured to be operated by a user pulling the pull tab 572 longitudinally outward (e.g., pulling the front actuator in the forward direction F or pulling the back actuator in the backward direction B). When the front actuator 514 is pulled forward (F), the front release wedges 578 slide forward along the front guide channels 545 adjacent the front snap-in elements 544. The forward facing wedge surfaces of the front release wedges 578 move across the vertical plane of the front catches 550. As they cross the front catches 550, the front release wedges 578 are configured engage the front fillets 254 of the latch elements 240, 242 and thereby spread the front latch arms 244, 246 by cam action. In a similar way to the front actuator 514, when the back actuator is pulled backward (B), the back release wedges 578 slide backward along the back guide channels 547 adjacent the back snap-in elements 546. The backward facing wedge surfaces of the back release wedges 578 move across the vertical plane of the back catches 554. As they cross the back catches 554, the back release wedges 578 are configured engage the back fillets 258 of the latch elements 240, 242 and thereby spread the front latch arms 244, 246 by cam action.

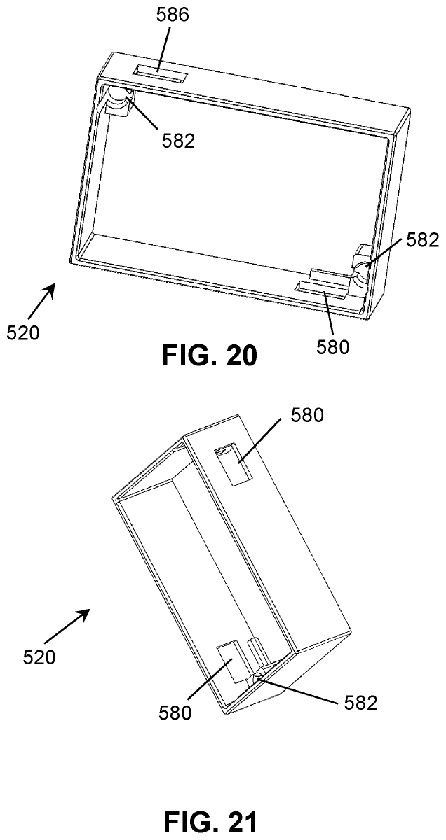

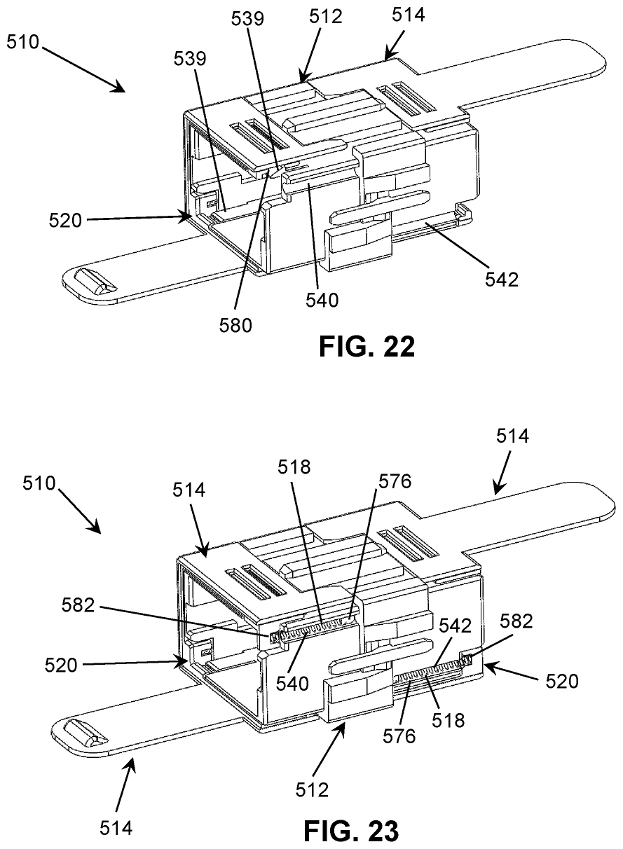

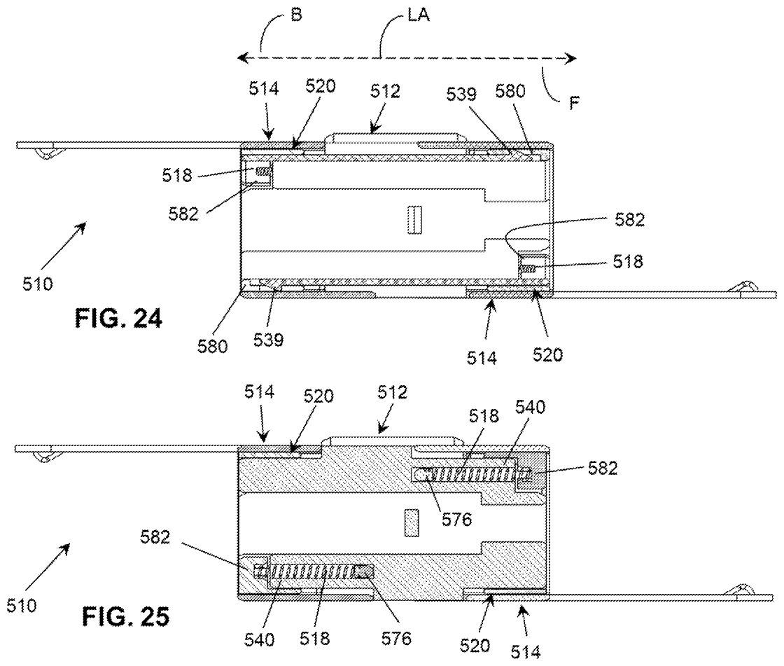

Referring to FIGS. 20-21, the front and back retainers 520 are substantially identical. Each retainer 520 comprises a rectangular body having an upper portion, a lower portion, and opposite side portions. Two opposite corner regions of the retainer 520 comprise features for securing the retainer to an end portion of the main body 512 and bracing the outer end portions of the actuator springs 518. More particularly, at each of the two corner regions, the upper or lower portion of the retainer body defines a latch recess 580, and the retainer 520 comprises a spring pad 582 protruding inward from the side portion. Referring to FIGS. 22-25, the front and back retainers 520 are configured to be pressed onto the front and back end portions of the main body 512, whereby the retainer latches 539 snap into the latch recesses 580 to secure the retainers on the main body. During assembly, the retainers 520 are placed on the main body 512 after the actuators 514 and actuator springs 518 so that the actuator spring pads 576 are received in the spring channels 540, 542 inboard of the springs and the retainer spring pads 582 brace the outer ends of the springs. This way, the retainers 520 load the actuator springs 518 against the actuator spring pads 576 to yieldably bias the front and back actuators 514 to their inner positions in relation to the main body 512.

FIGS. 26-27 provide a cross-sectional illustration of how the spring is loaded when the front actuator 514 is pulled forward. It will be understood that essentially the same spring loading action occurs when the back actuator 514 is pulled backward. FIG. 26 shows the front actuator 514 at its inner position, and FIG. 27 shows the front actuator pulled outward from its inner position in the forward direction F. As shown in FIG. 27, the front actuator 514 is displaced in relation to the main body 512 by a throw length L. The front actuator spring pad 576 thus moves in the forward direction F along the front spring channel 540 and compresses the actuator spring 518, the front end of which is braced by the spring pad 582 of the front retainer 520. In this position, the front actuator springs 518 are urging the front actuator 514 in the forward direction F so that when the pulling force is released, the springs will drive the front actuator 514 backward to its natural inner longitudinal position seen in FIG. 26.

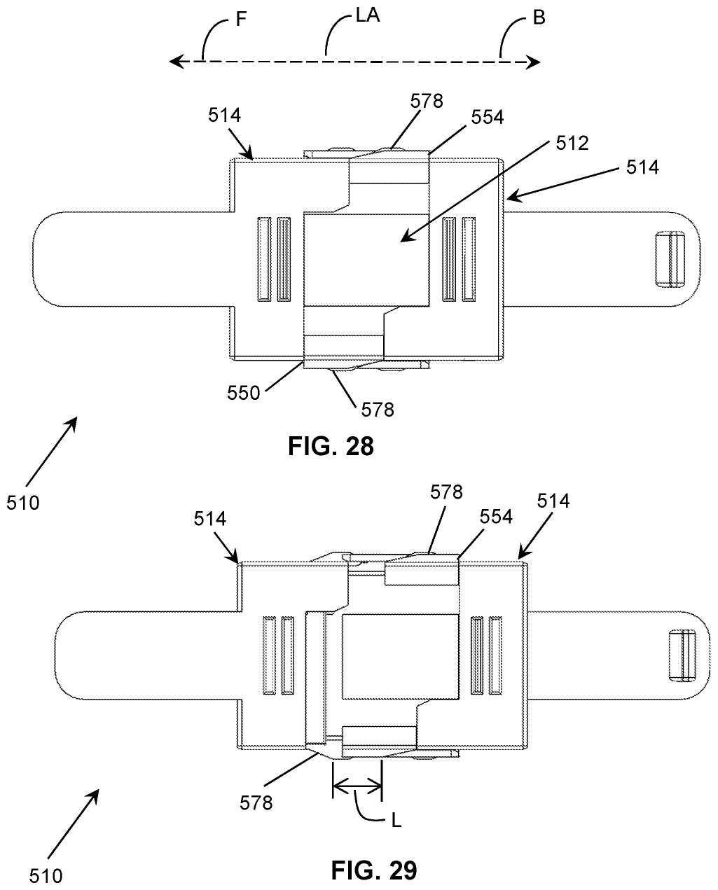

FIGS. 28 and 29 provide a bottom external view of how the front actuator 514 moves in relation to the main body 512 when pulled in the forward direction F. It will be understood that essentially the action occurs in the opposite direction when the back actuator 514 is pulled backward. FIG. 28 shows the front actuator 514 at its inner position, and FIG. 29 shows the front actuator pulled forward. As can be seen, the front wedge 578 crosses the plane of the front catch 550 as the front actuator moves from the forward position to the backward position.

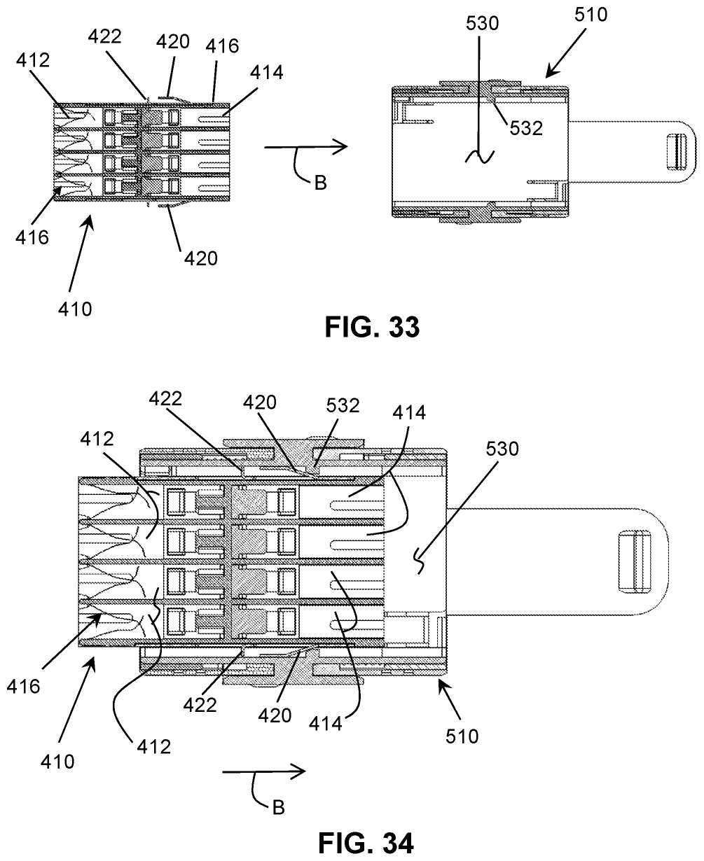

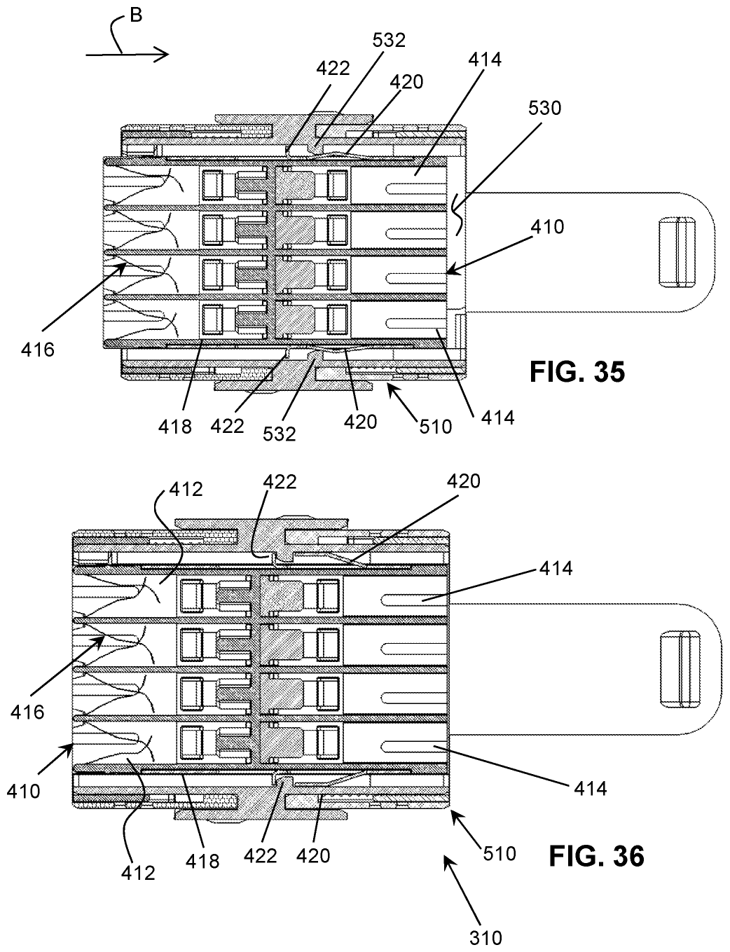

FIGS. 30-36 illustrate how the adapter 410 can be installed in the insert cartridge 510 to form the adapter assembly. As shown, the adapter 410 is inserted into front end of the adapter opening 530 in the backward direction B. As the adapter 410 moves backward along the adapter opening 530, the spring arms 420 are compressed by the internal catch features 532 of the main body 512. When the spring arms 420 clear the catch features 532, they resiliently rebound to their natural positions, capturing the catch features between the front ends of the spring arms and fixed retention flanges 422 of the panel clip 418.

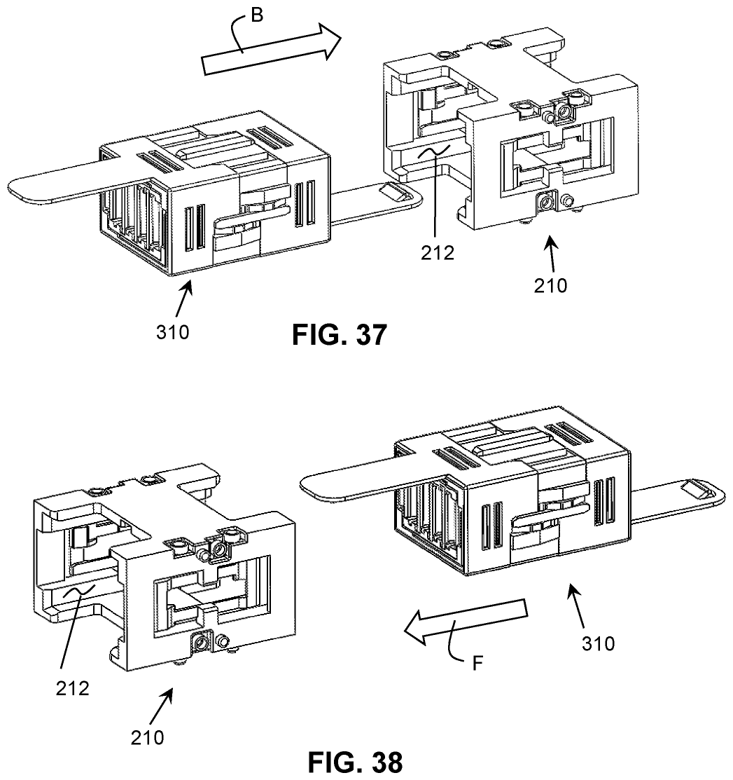

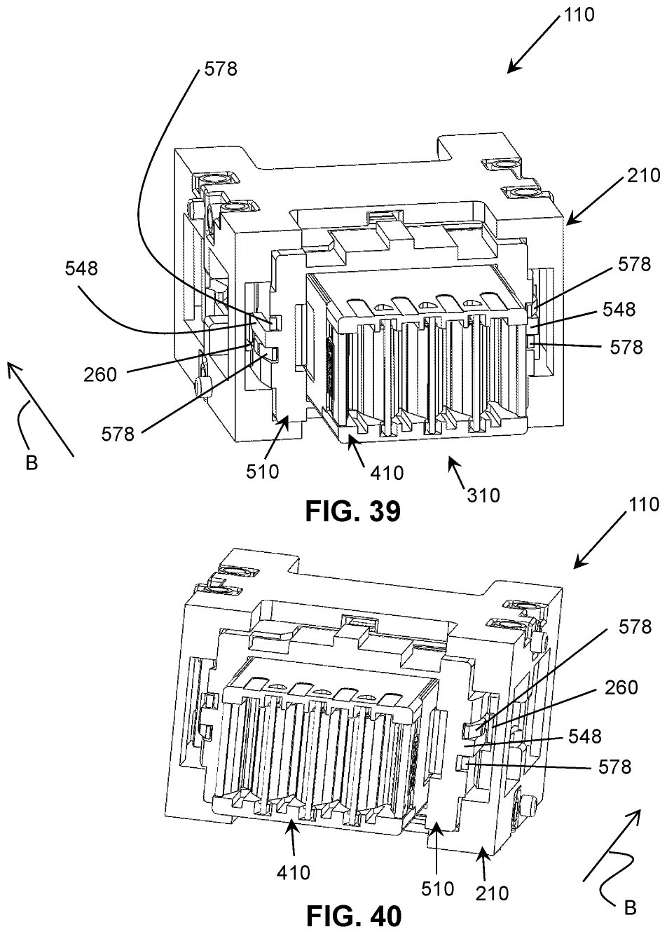

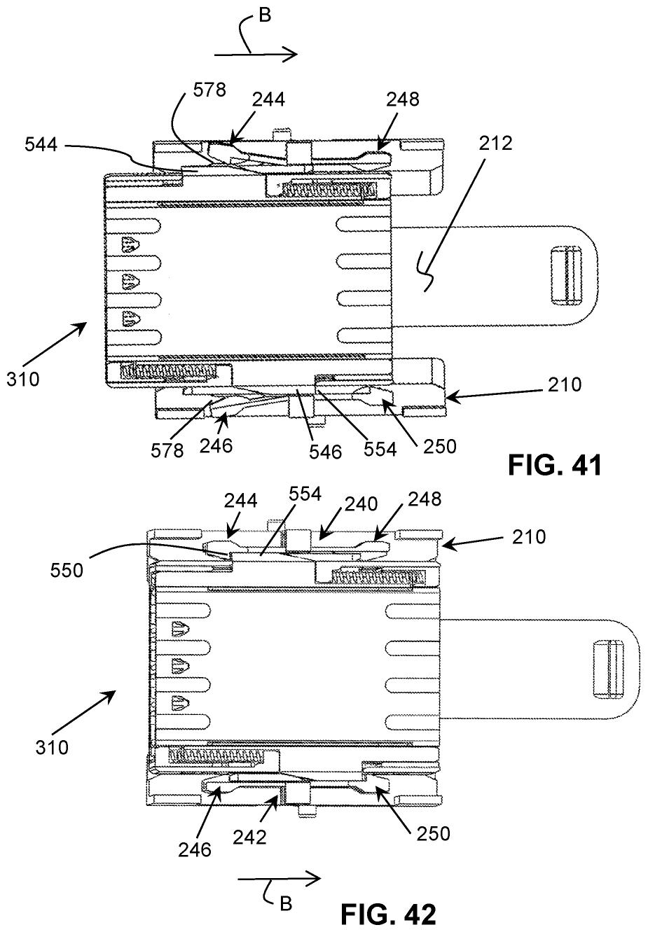

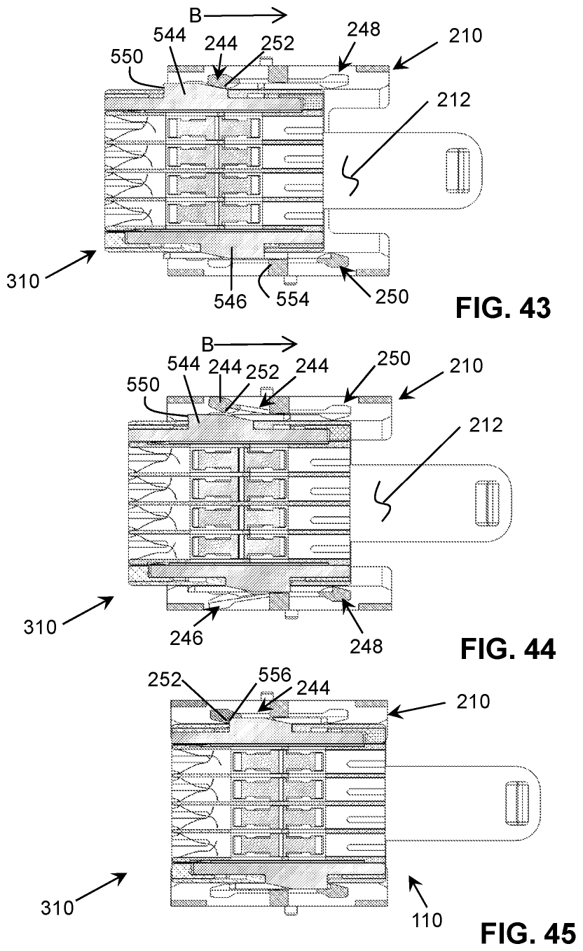

FIGS. 37-38 illustrate how the adapter assembly 310 is loadable into the assembly opening 212 of the cage 210 by (i) inserting the adapter assembly forward into the back end portion of the cage (FIG. 38) and (ii) inserting the adapter assembly backward into the front end portion of the cage (FIG. 37). That is, the adapter assembly 310 is configured for bidirectional insertion into the cage 210. FIGS. 39-40 illustrate certain details regarding how the adapter assembly 310 is operatively loaded into the cage 210 when inserted from the front end in the backward direction B. FIGS. 39-40 illustrate how, along each of the left and right portions of the cage 210, the adjacent guide rib 548 of the adapter assembly main body 512 and the adjacent release wedge 578 of the back actuator 514 are received in the gaps 260, 262 between upper and lower portions of the latch elements 240, 242. The adjacent latch release wedge 578 of the front actuator 514, by contrast, is aligned with the respective front latch arm 244, 246. FIGS. 41-45 illustrate how the wedges 552 of the front snap-in elements 544 and the release wedges 578 of the front actuator 514 spread the front latch arms 244, 246 outward as the adapter assembly 310 is inserted into the assembly opening 212 in the backward direction B. In FIGS. 41 and 42, the insert cartridge 510 is shown in section and the other components of the connection system 110 are shown in full. When latch hooks 252 of the front latch arms 244, 246 move longitudinally past the catches 550 of the front snap-in elements 544, the front latch arms rebound and the backward facing latch hooks latch with the catches as seen in FIGS. 42 and 45. As illustrated in FIGS. 41-45, the back latch arms 248, 250 do not move when the adapter assembly 310 is inserted into the cage 210 in the backward direction B.

Although not shown in separate drawings, those skilled in the art will recognize that the latching mechanism operates in essentially the same manner but opposite direction when the adapter assembly 310 is inserted in the forward direction F into the back end of the cage 210. Along each side portion of the cage 210, the adjacent guide rib 548 and the adjacent release wedge 578 of the front actuator 514 are received in the gaps 260, 262 between upper and lower portions of the latch elements 240, 242. The adjacent latch release wedge 578 of the back actuator 514, by contrast, is aligned with the respective back latch arm 248, 250. As the adapter assembly 310 advances in the forward direction F, the wedges 552 of the back snap-in elements 546 and the release wedges 578 of the back actuator 514 spread the back latch arms 248, 250 outward. When latch hooks 256 of the back latch arms 248, 250 move longitudinally past the catches 554 of the back snap-in elements 546, the back latch arms rebound and the forward facing latch hooks latch with the back catches. The front latch arms 244, 246 do not move when the adapter assembly 310 is inserted into the cage 210 in the forward direction B.

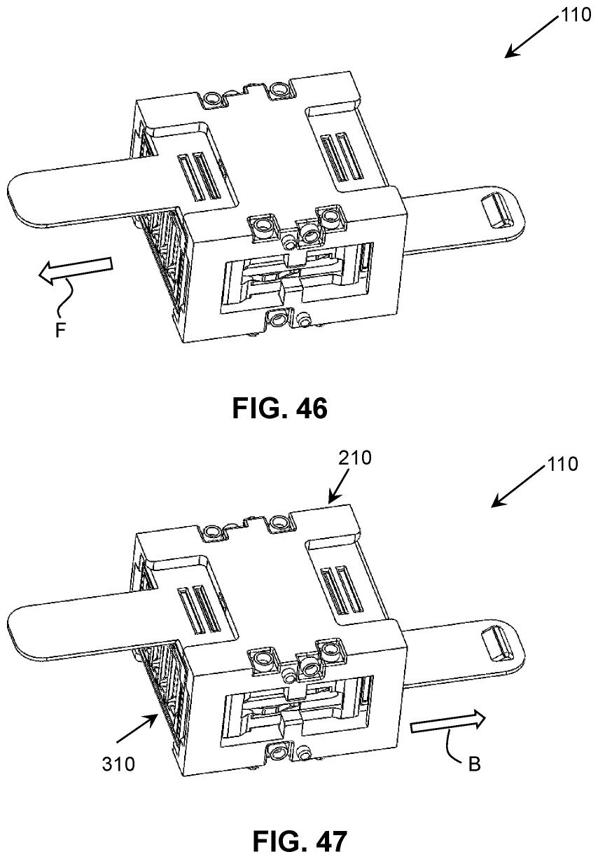

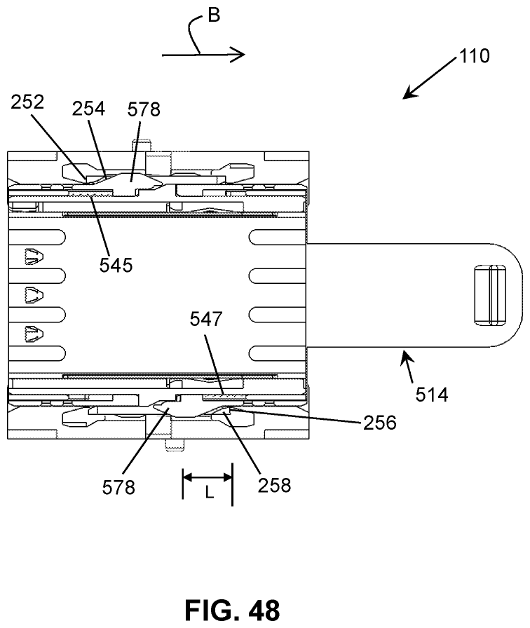

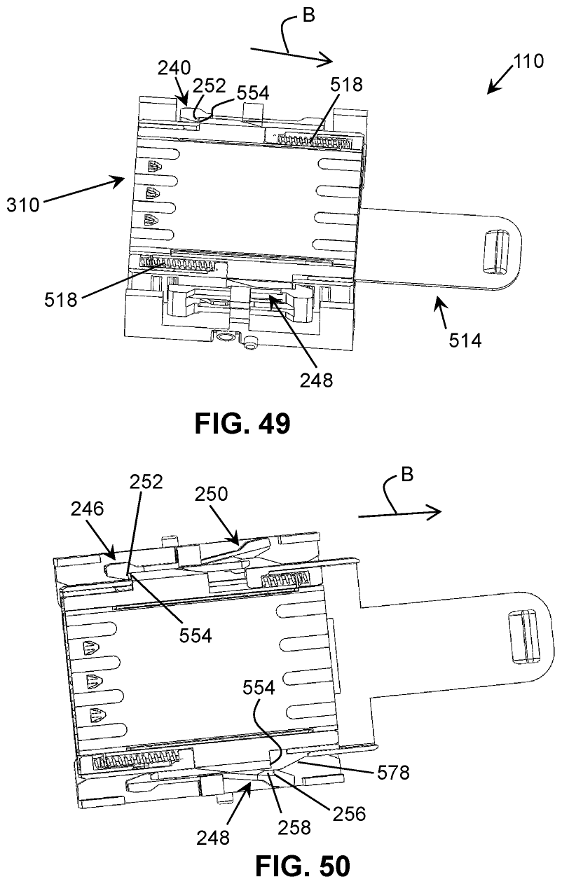

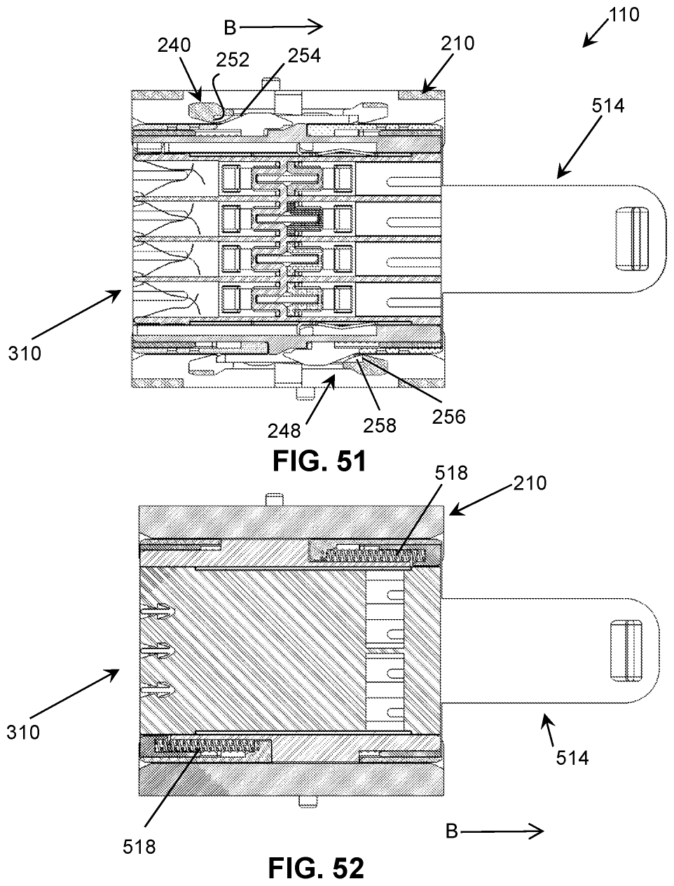

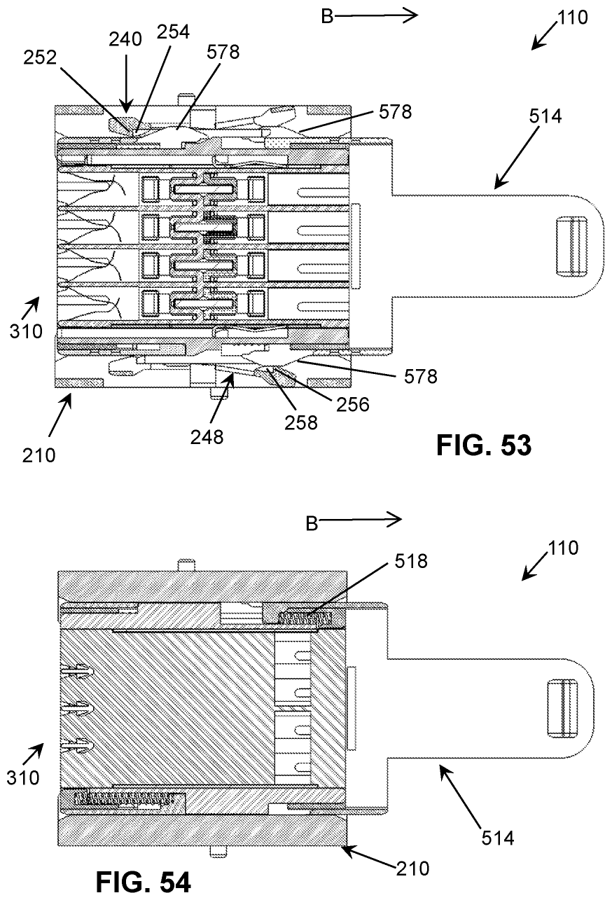

FIGS. 46 and 47 illustrate how the adapter assembly 310 can be unloaded from the cage 210 by (a) extracting the adapter assembly backward from the back end portion of the cage (FIGS. 47 and 48) and (b) extracting the adapter assembly forward from the front end portion of the cage (FIG. 46). FIGS. 49-54 illustrate how the adapter assembly 310 can be extracted in the backward direction B from the back end of the cage 210. The user pulls the back actuator 514 in the backward direction B, displacing the back actuator 514 in relation to the main body 512 of the insert cartridge 510 and the cage 210. This compresses the back actuator springs 518 and causes the back release wedges 578 to slide backward along the back guide channels 547. The backward facing wedge surfaces of the back release wedges 578 move across the vertical plane of the back catches 554. As they cross the back catches 554, the back release wedges 578 engage the back fillets 258 of the cage latch elements 240, 242 and thereby spread the back latch arms 248, 250 by cam action. Spreading the back latch arms 248, 250 unlatches the forward facing latch hooks 256 from the catches 554 so that the entire adapter assembly 310 is freed for backward extraction.

Although not shown in separate drawings, those skilled in the art will recognize that the bidirectional extraction mechanism operates in essentially the same manner but opposite direction when the adapter assembly 310 is extracted in the forward direction F from the front end of the cage 210. The user pulls the front actuator 514 in the forward direction F, displacing the front actuator 514 in relation to the main body 512 of the insert cartridge 510 and the cage 210. This compresses the front actuator springs 518 and causes the front release wedges 578 to slide forward along the front guide channels 545. The forward facing wedge surfaces of the front release wedges 578 move across the vertical plane of the front catches 550. As they cross the front catches 550, the front release wedges 578 engage the front fillets 254 of the cage latch elements 240, 242 and thereby spread the front latch arms 244, 246 by cam action. Spreading the front latch arms 244, 246 unlatches the backward facing latch hooks 252 from the catches 550 so that the entire adapter assembly 310 is freed for forward extraction.

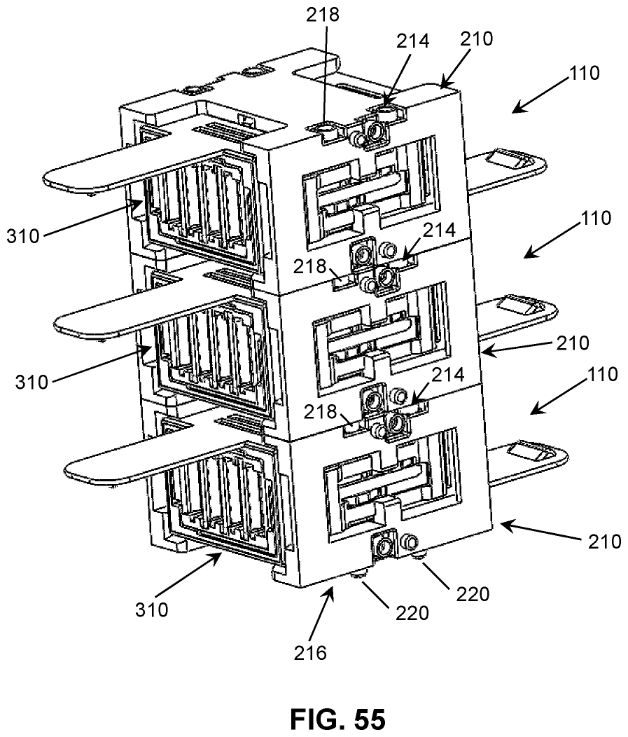

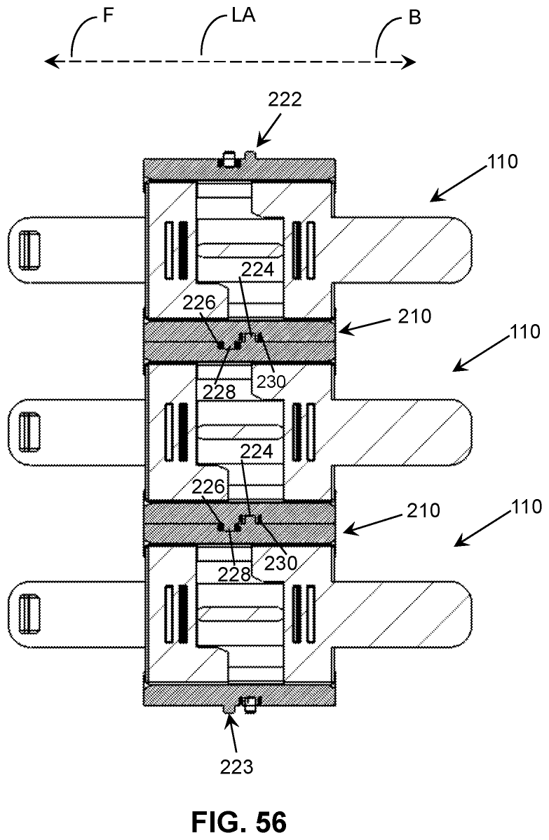

FIG. 55 illustrates a plurality of fiber optic connection assemblies 110 in a vertical stack. It will be understood that the lower stacking interfaces 216 of the upper two cages 210 in FIG. 56 are mated with the upper stacking interfaces 214 of the lower two cages. Accordingly, the posts 220 of the upper two cages 210 are press fit into the sockets 218 of the upper two cages.

FIG. 56 illustrates a plurality of fiber optic connection assemblies in a side-by-side stack. The left stacking interfaces 222 of the two right cages 210 are mated with the right stacking interfaces 223 of the adjacent cages on their left. Hence, the posts 224 and sockets 226 of the two right cages are press fit against the complementary posts 228 and sockets 230 of the adjacent cages on their left.

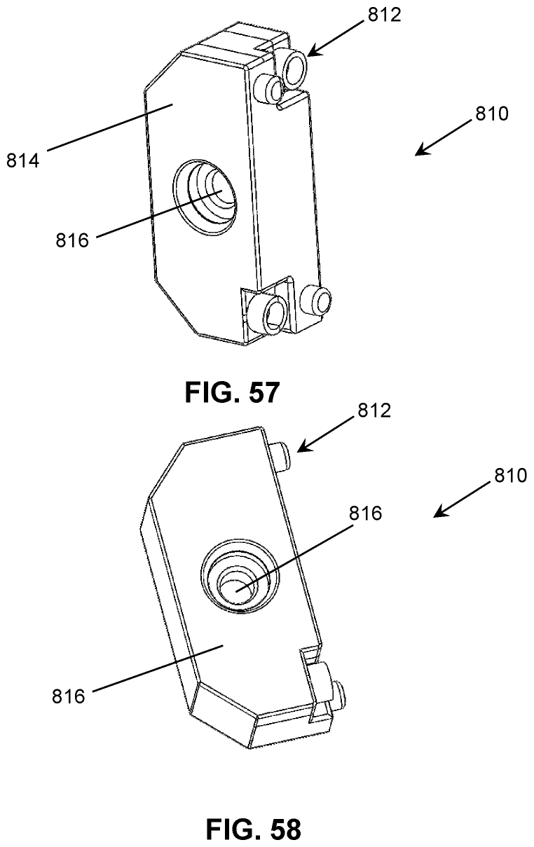

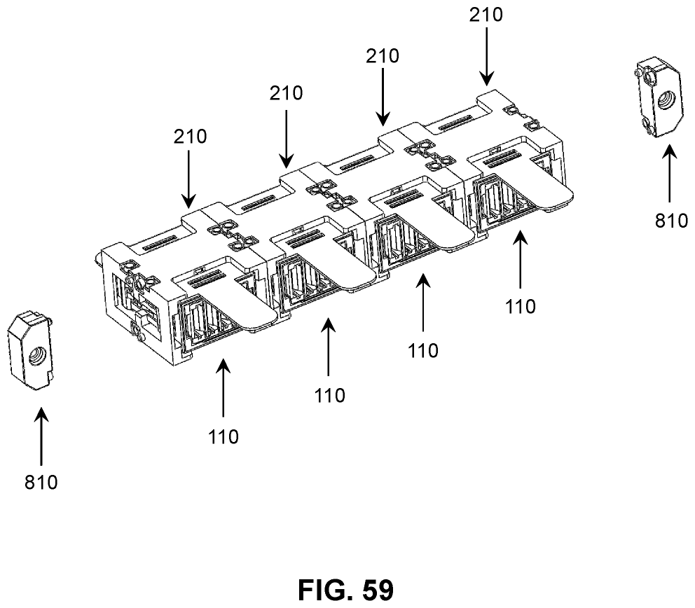

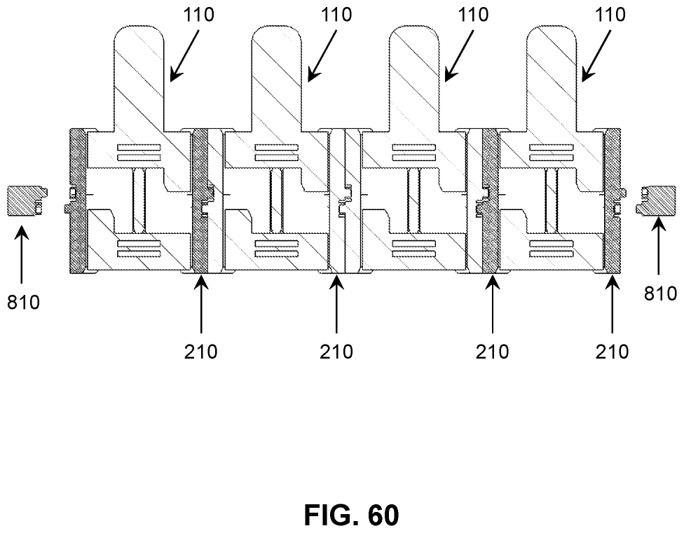

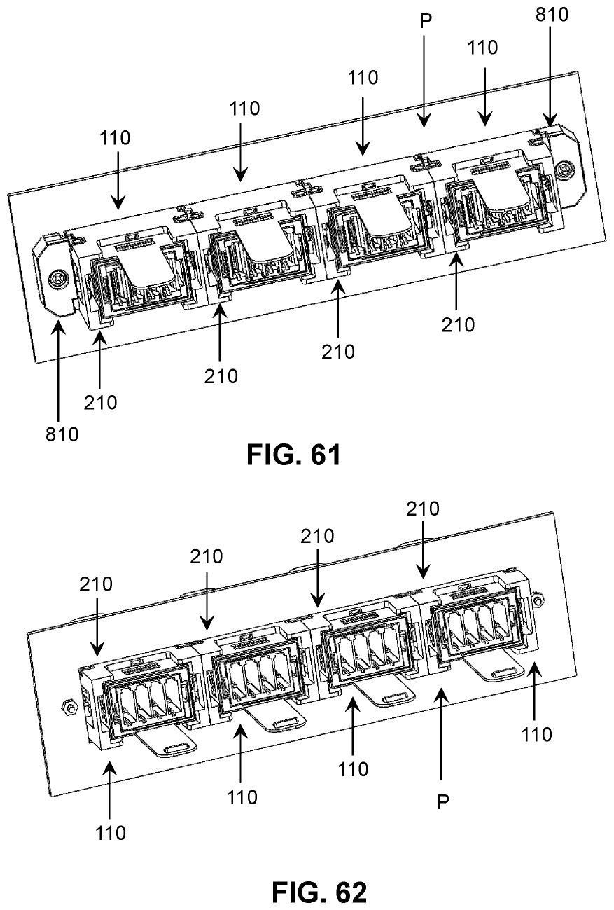

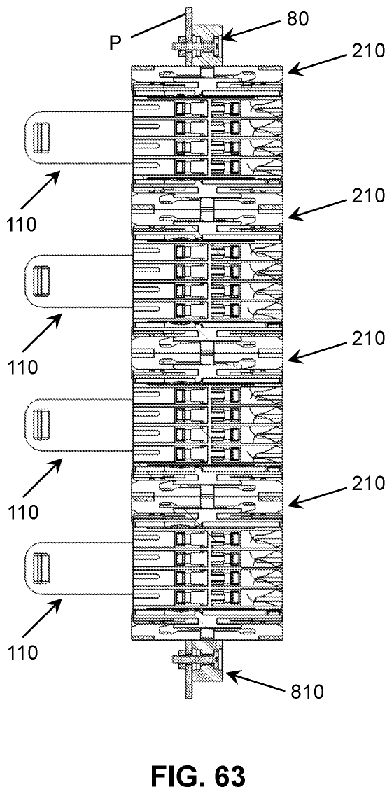

Referring to FIGS. 57-63, in one or more embodiments fiber optic connection systems in the scope of this disclosure can include left and right panel flange members 810. Each panel flange member 810 comprises a side-by-side stacking interface 812 configured to mate with either side stacking interface 222, 223 of the cage 210. In addition, each panel flange member 810 further comprises a flange body 814 defining a fastener hole 816 configured to receive a panel fastener for securing the flange to a panel P. In use, one panel flange member 810 is secured to a leftmost cage 210 in a side-by-side cage stack and another panel flange member is secured to the rightmost cage in the side-by-side cage stack. The panel flange members 810 and the side-by-side stack of cages 210 form a panel assembly that can be mounted as a unit onto a panel P in a similar manner to a conventional panel-mounted optical cassette.

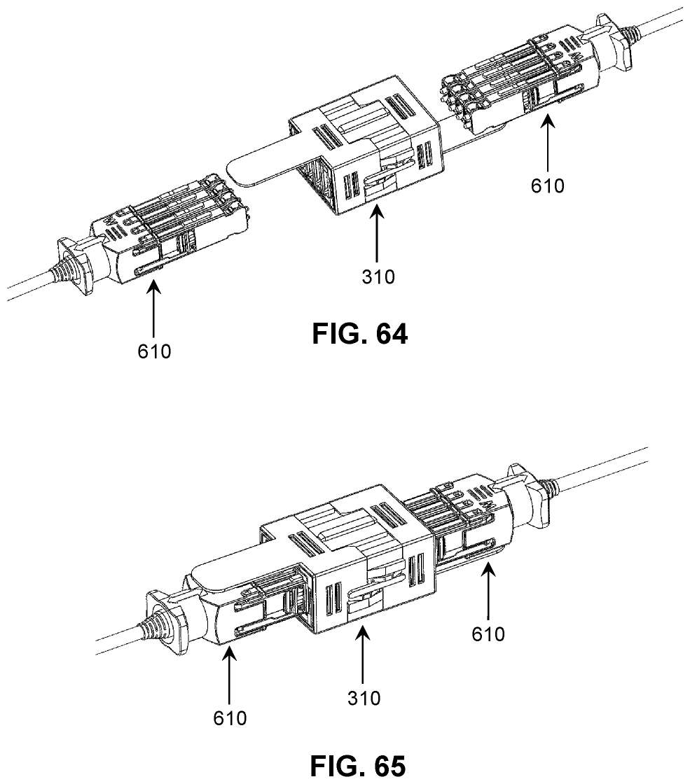

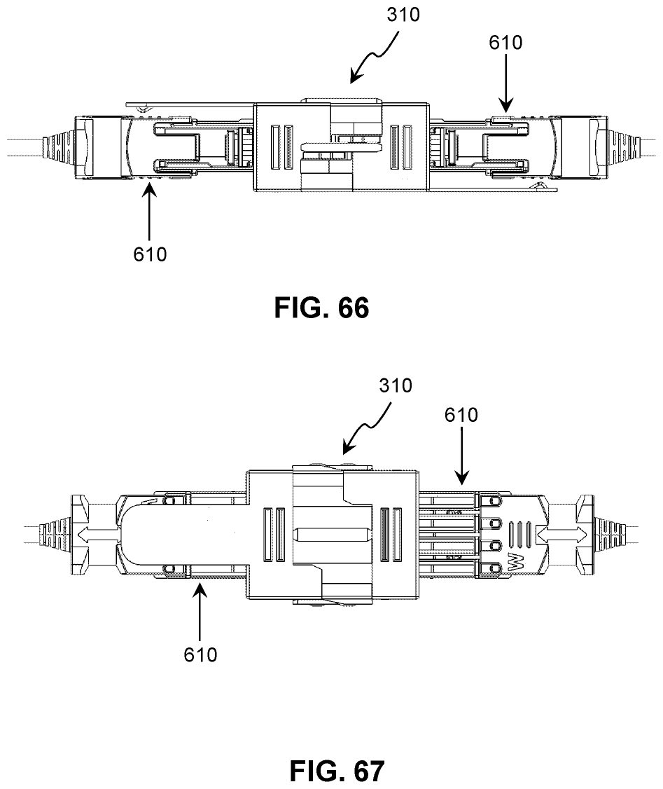

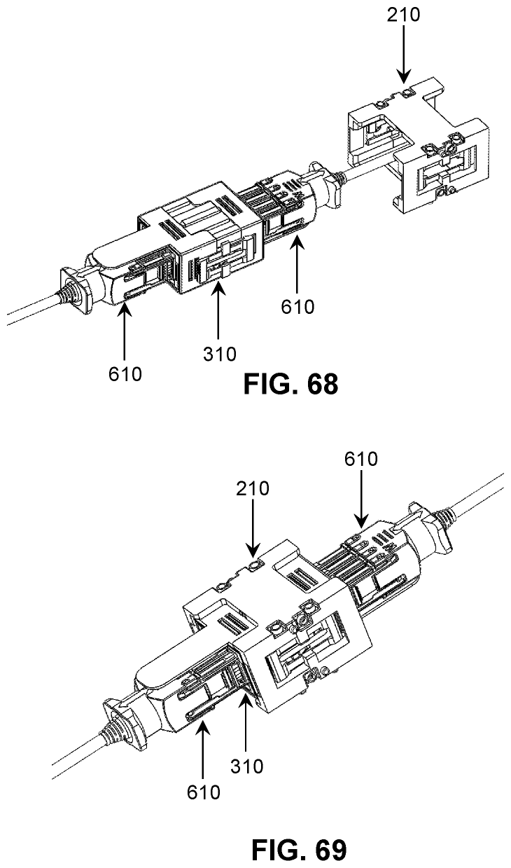

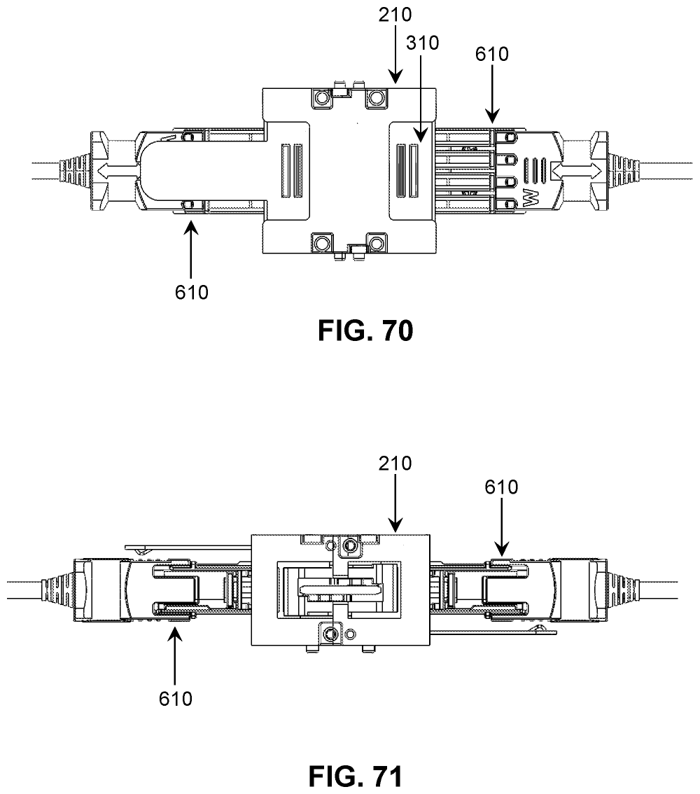

Referring to FIGS. 64-73, exemplary methods of using the optical connection system 110 will now be described. As indicated in FIGS. 64-65, in certain embodiments, one or more fiber optic connectors 610 can be mated with the adapter assembly 310 (via adapter receptacles 412, 414) before the adapter assembly 310 is installed in the cage 210. In FIGS. 64-65, an example is shown where uniboot connectors 610 are plugged into both the front end and back end of the adapter assembly 310. The inventors also expressly contemplate fiber optic installation methods in which connector(s) are plugged into only one end of the adapter assembly 310 before cage mounting. For example, the inventors believe it may be useful to install a trunk cable connector 610 in the back end of the adapter assembly 310 before installing the adapter assembly in a cage. This can allow the cabling installer to make the back end plug-in connection to the adapter 410 at a location where there is ample space, before loading the adapter assembly 310 into a cage 210 on a high density panel P where there is less room to maneuver. As shown in FIGS. 68-71, the adapter assembly 310 can be loaded into the cage 210 (in either the forward direction F or the backward direction B) after one or more connectors 610 are mated to one or both ends of the adapter assembly. In other words, the adapter assembly 310 and one or more mated connectors 610 are loaded into the cage 210 together as a unit. Referring to FIGS. 72-73, after the adapter assembly 310 has been loaded into the cage 210 and one or more connectors 610 are mated with the adapter assembly, the front and back extraction actuators 514 can be used to extract the adapter assembly 310 and mated connectors 610 from the cage 210 together as a unit in either the forward direction (FIG. 72) or the backward direction (FIG. 73).

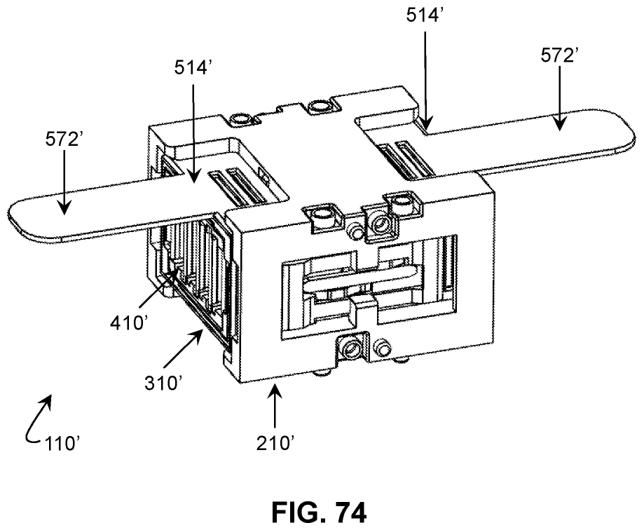

It will be appreciated that various modifications to the connection assembly 110 are possible without departing from the scope of the disclosure. For example, referring to FIG. 74, one embodiment of a connection assembly 110′ comprises a cage 210′ similar to the cage 210 and adapter assembly 310′ similar to the adapter assembly 310, except that both the front and back pull tabs 572′ of the extraction actuators 514′ are on the same side of the adapter 410′ (e.g., both pull tabs 572′ are above the top of the adapter 410′).

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A fiber optic connection assembly configured to mate with at least one fiber optic connector, the fiber optic connection assembly comprising:
a cage having a front end portion and a back end portion spaced apart along the longitudinal axis, the cage defining an assembly opening extending from the front end portion through the back end portion, the cage comprising a latch element,
an adapter assembly configured to latch with the latch element to be releasably secured in the assembly opening, the adapter assembly having at least one receptacle for receiving the at least one fiber optic connector, the adapter assembly being loadable into the assembly opening by (i) inserting the adapter assembly forward into the back end portion of the cage and (ii) inserting the adapter assembly backward into the front end portion of the cage, the adapter assembly comprising a bidirectional extraction mechanism configured to be selectively actuated for unloading the adapter assembly from the assembly opening by (a) extracting the adapter assembly backward from the back end portion of the cage and (b) extracting the adapter assembly forward from the front end portion of the cage.

2. The fiber optic connection assembly as set forth in claim 1, wherein the adapter assembly includes an insert cartridge comprising the bidirectional extraction mechanism and an adapter defining the at least one receptacle, the adapter being secured in the insert cartridge.

3. The fiber optic connection assembly as set forth in claim 2, wherein the insert cartridge comprises a main body and wherein the bidirectional extraction mechanism comprises a front actuator movably connected to the main body and a back actuator movably connected to the main body independent of the front actuator.

4. The fiber optic connection assembly as set forth in claim 3, wherein each of the front actuator and the back actuator comprises a pull tab protruding longitudinally in relation to the main body.

5. The fiber optic connection assembly as set forth in claim 4, wherein each pull tab is above the adapter.

6. The fiber optic connection assembly as set forth in claim 5, wherein one of the pull tabs is above the adaptor and the other pull tab is below the adapter.

7. The fiber optic connection assembly as set forth in claim 3, wherein the cage comprises a front latch arm defining a backward facing latch hook and a back latch arm defining a forward facing latch hook.

8. The fiber optic connection assembly as set forth in claim 7, wherein the main body comprises a front catch and a back catch, the main body configured so that when the adapter assembly is secured in the assembly opening, the front catch and the back catch oppose the backward facing latch hook and the forward facing latch hook, respectively, whereby the main body is retained longitudinally between the front latch arm and the back latch arm.

9. The fiber optic connection assembly as set forth in claim 8, wherein the adapter assembly and the cage are configured so that, as the adapter assembly is loaded into the assembly opening by inserting the adapter assembly forward into the back end portion of the cage, the back latch arm rotates to latch with the back catch and the front latch arm does not rotate; wherein the adapter assembly and the cage are configured so that, as the adapter assembly is loaded into the assembly opening by inserting the adapter assembly backward into the front end portion of the cage, the front latch arm rotates to latch with the front catch and the back latch arm does not rotate.

10. The fiber optic connection assembly as set forth in claim 8, wherein each of the front actuator and the back actuator is movable in relation to the main body through range of motion along the longitudinal axis including a respective inner longitudinal position and a respective outer longitudinal position.

11. The fiber optic connection assembly as set forth in claim 10, wherein the front actuator comprises a front latch release wedge configured to unlatch the front latch arm from the front catch as the front actuator moves from the respective inner longitudinal position toward the respective outer longitudinal position, and wherein the back actuator comprises a back latch release wedge configured to unlatch the back latch arm from the back catch as the back actuator moves from the respective inner longitudinal position toward the respective outer longitudinal position.

12. The fiber optic connection assembly as set forth in claim 10, further comprising a front actuator spring loaded for yieldably biasing the front actuator toward the respective inner longitudinal position and a back actuator spring loaded for yieldably biasing the back actuator toward the respective inner longitudinal position.

13. The fiber optic connection assembly as set forth in claim 11, further comprising a front retainer and a back retainer secured to the main body, the front actuator spring being compressed between the front retainer and the front actuator and the back actuator spring being compressed between the back retainer and the back actuator.

14. The fiber optic connection assembly as set forth in claim 2, wherein the adapter is configured to mate with a uniboot connector.

15. The fiber optic connection assembly as set forth in claim 1, wherein the cage comprises an upper portion, a lower portion, a left portion, and a right portion.

16. The fiber optic connection assembly as set forth in claim 15, wherein the upper portion defines an upper stacking interface and the lower portion defines a complementary lower stacking interface, the upper stacking interface configured to mate with the complementary lower stacking interface of an identical cage to facilitate vertical cage stacking.

17. The fiber optic connection assembly as set forth in claim 15, wherein the left portion defines a left stacking interface and the right portion defines a complementary right stacking interface, the left stacking interface configured to mate with the complementary right stacking interface of an identical cage to facilitate side-by-side cage stacking.

18. A fiber optic panel assembly comprising the fiber optic connection assembly of claim 17 and a plurality of identical cages, the plurality of identical cages stacked side-by-side using the left stacking interfaces and complementary right stacking interfaces, the fiber optic connection assembly further comprising a left panel flange secured to the left stacking interface of a leftmost one of the plurality of identical cages and a right panel flange secured to the right stacking interface of a rightmost one of the plurality of identical cages.

19. A method of installing a fiber optic trunk cable, the method comprising:
plugging one or more trunk cable connectors terminating the trunk cable into one or more back receptacles of an adapter assembly; and
after said plugging, inserting the adapter assembly forward into a back end portion of a cage to load the adapter assembly into an assembly opening of the cage.

20. A fiber optic connection assembly comprising:
a cage having a front end portion and a back end portion spaced apart along a longitudinal axis, the cage having an assembly opening extending from the front end portion through the back end portion;
an adapter assembly releasably secured in the assembly opening, the adapter assembly having at least one front receptacle and at least one back receptacle;
at least one front connector mated with the adapter assembly in the at least one front receptacle;
at least one back connector mated to the receptacle in the at least one back receptacle, the adapter assembly securing the at least one front connector and the at least one back receptacle such that an optical connection is made between the at least one front connector and the at least one back receptacle;
wherein the adapter assembly is selectively releasable from the cage such that the adapter assembly can be extracted backward from the back end portion of the cage while the at least one front connector remains mated with the adapter assembly in the at least one front receptacle and the at least one back connector remains mated with the adapter assembly in the at least one back connector;
wherein the adapter assembly is also selectively releasable from the cage such that the adapter assembly can be extracted forward from the front end portion of the cage while the at least one front connector remains mated with the adapter assembly in the at least one front receptacle and the at least one back connector remains mated with the adapter assembly in the at least one back receptacle.
